(19) United States
(12) Patent Application Publication
(10) Pub. No.: US 2025/0345997 A1
(43) Pub. Date: Nov. 13, 2025

(54) EXTRUSION HEAD FOR ADDITIVE MANUFACTURING

(71) Applicant: Florian ROHRMOSER, Grossarl (AT)

(72) Inventor: Florian ROHRMOSER, Grossarl (AT)

(21) Appl. No.: 19/276,469

(22) Filed: Jul. 22, 2025

Related U.S. Application Data
(63) Continuation of application No. PCT/AT2024/060013, filed on Jan. 19, 2024.

(30) Foreign Application Priority Data
Jan. 24, 2023 (AT) A 50034/2023

(51) Int. Cl. B29C 64/30; B29C 64/209; B33Y 30/00; B33Y 40/20

(52) U.S. Cl. CPC B29C 64/30; B29C 64/209; B33Y 30/00; B33Y 40/20

(57) ABSTRACT

An extrusion head for additive manufacturing of a product, including a material feed unit for feeding an extrusion material, preferably in filament form, a separating device with a blade element, and a displacement unit with at least two liquefying assemblies. The extrusion material can be introduced into a first liquefying assembly and, by passing the displacement unit past the separating device in an approximately gap-free manner such that the extrusion material can be brought close to the blade element and can be severed at a severing point, the upper end of the extrusion material can be introduced into a second liquefying assembly. The blade element can be fastened or is fastened to or in the material feed unit or is a component of the material feed unit.

The present application is a continuation of International Application PCT/AT2024/060013 filed on Jan. 19, 2024. Thus, all of the subject matter of International Application PCT/AT2024/060013 is incorporated herein by reference.

### BACKGROUND OF THE INVENTION

The present invention relates to an extrusion head and to a method and/or use for manufacturing a product by at least one such extrusion head.

In the course of manufacturing products using additive manufacturing processes, such as fused filament fabrication (FFF), there are a variety of different requirements. It is desirable that products with complex designs be manufactured. Since in the field of additive manufacturing, the products to be manufactured are produced piece by piece, specifically layer by layer, it is often difficult to produce complex shapes with high processing speeds and high processing accuracies.

If more than one processing material must or should be used for a product, many manufacturing devices used to manufacture these products reach their process engineering limits. This can be the case, for example, if a product is to be manufactured from a first material A, whereby the product has undercuts due to its complex shape which cannot be produced in a layer-by-layer construction without support structures made from a second material B. It may also be intended to construct a product from several materials or to offer the possibility of using a cleaning material. It is already known from the prior art, for example from EP 3 725 497 A1, that more than one material can be processed within an additive manufacturing device.

It is also known from the prior art that a cutting device may be provided in addition to an extrusion device. Such a cutting device cuts off the material intended for additive manufacturing, which is often in the form of a filament, after extrusion.

Many challenges for additive manufacturing processes arise from the fact that they are now used in a wide range of industrial applications. In contrast to the private sector, where small do-it-yourself devices are often used, industrial applications place increasing demands on efficiency, accuracy, process stability, temperature limits, space constraints, product sizes, and the like. To ensure that the economic efficiency of the complex manufacturing process does not suffer, or at least not excessively, from the increased performance and the more difficult mechanical and chemical stresses, it is essential that additive manufacturing systems are designed to be as reliable, cost-effective, maintenance-friendly, and low-maintenance as possible.

A specific challenge for an additive manufacturing process in the industrial sector is to develop a highly efficient, very precise, and, above all, process-reliable fused filament fabrication system for high ambient temperatures and nozzle temperatures that meets the high standards of the aerospace, railway, and automotive industries.

High nozzle temperatures, well above the melting temperature, of up to 440° C. are required for processing high-performance plastics such as polyether ether ketone (PEEK) in large quantities. To ensure that the crystalline structure of the plastic is formed correctly so that the extrusion material has the highest possible strength, heated chambers must be kept at constant and homogeneous temperatures of approx. 220° C. to even 250° C.

The current state of the art has various disadvantages. On the one hand, extrusion material is often not cut cleanly or reliably but is additionally deformed during the cutting process. This is particularly disadvantageous if a cut piece of extrusion material, such as a filament, is bent and has to be reinserted into a guide for further processing after cutting. On the other hand, cobweb-like thread formation can occur during cutting because the softened extrusion material is not cut cleanly or reliably.

### SUMMARY OF THE INVENTION

The task of the present invention is therefore to at least partially overcome the disadvantages of the prior art and to provide an extrusion head that is improved over the prior art and is characterized in particular by a cleaner cutting process of the extrusion material and/or higher process reliability. The task is also to provide an arrangement with such an extrusion head. The task is also to provide a method and/or use for manufacturing a product with such an improved extrusion head.

This task is solved by an extrusion head as described below, namely by providing an extrusion head for additive manufacturing, preferably for the fused filament fabrication method, of a product comprising at least one material feed unit for feeding at least one extrusion material, preferably in filament form, a separating device with at least one blade element, and at least one displacement unit with at least two liquefying assemblies. The at least one extrusion material can be introduced into a first liquefying assembly and, by passing the at least one displacement unit past the at least one separating device in an approximately gap-free manner, the extrusion material can be brought close to the at least one blade element and can be severed at a severing point, and the upper end of the extrusion material severed by the separating device can be introduced into a second liquefying assembly, wherein the at least one blade element can be fastened or is fastened to or in the at least one material feed unit or is provided as a component of the material feed unit.

By “passing the at least one displacement unit past the at least one separating device with approximately no gaps,” it is understood here that at least at one point between the at least one displacement unit and the at least one material feed unit and/or the at least one separating device and/or the at least one blade element, there is a cutting gap with a maximum distance of 50% of the nominal width of the extrusion material, preferably 25%, particularly preferably only 12% of the nominal width of the extrusion material in filament form.

Due to the approximately gap-free passage of the at least one displacement unit past the at least one separating device and due to the blade element attached to or in the at least one material feed unit, the extrusion material can be cut cleanly with the blade element without the extrusion material being additionally deformed, for example bent. This means that part of the extrusion material remains in the material feed unit and the other part of the extrusion material remains in a first liquefying assembly of the displacement unit. Subsequently, the upper severed end of the extrusion material can either be introduced into a second liquefying assembly by passing the at least one displacement unit past the at least one material feed unit, or into the first liquefying assembly by returning the displacement unit to the at least one material feed unit. In any case, the extrusion material is essentially not deformed away from the severing point.

The solution described above thus ensures reliable cutting and/or a change of liquefying assemblies and/or a change of nozzles and/or a change of extrusion materials. Contamination and/or damage caused by the otherwise necessary withdrawal of the already softened or partially liquefied extrusion material can thus also be avoided.

After cutting, the extrusion material is fed into one of the liquefying assemblies for further processing and conveyed to the nozzle. If there is already a residual piece of extrusion material in the liquefying assembly into which the cut extrusion material is fed, the residual piece is also conveyed by the newly fed extrusion material.

The fused filament fabrication method, FFF method, is an additive manufacturing process. The term fused deposition modeling, FDM method, is synonymous with the FFF method. The FFF method is a 3D printing technique and is generally classified as an additive manufacturing process. In this process, a product is built up layer by layer from a meltable extrusion material.

The extrusion material can be a plastic, a fiber-reinforced plastic, a composite plastic, and/or a metal.

According to a preferred embodiment of the extrusion head, the at least one blade element is round and/or angular.

According to a preferred embodiment of the extrusion head, the at least one blade element is designed as a flat plate or as a block or as a flat ring or as a sleeve.

According to a preferred embodiment of the extrusion head, the at least one blade element is connected to the at least one material feed unit by a blade connection device, preferably wherein the blade connection device can be detached without destruction.

In a preferred embodiment, the cutting gap can be adjusted discretely and/or continuously by loosening the blade connection device, then moving the at least one blade element, preferably along a wedge, and then securing the at least one blade element by means of the non-destructively releasable blade connection device.

According to a preferred embodiment of the extrusion head, the at least one blade element has at least one straight and/or curved cutting edge with a cutting surface underside and a cutting surface upper side, wherein, in the state of the at least one blade element being fixed to or in the material feed unit, the underside of the at least one blade element and the cutting surface underside face the displacement unit and the upper side of the at least one blade element and the cutting surface upper side face away from the displacement unit.

In a preferred embodiment, a multi-blade element may be provided, in which at least one cutting edge may be in use in a first installed state and a further cutting edge may be in use by changing the position in a further installed state.

In a preferred embodiment, the at least one blade element may be replaceable.

According to a preferred embodiment of the extrusion head, the cutting surface underside and the cutting surface upper side are arranged at an angle to each other, preferably at an angle of up to 55°, in particular at a very acute angle of 20 to 30°. According to a preferred embodiment of the extrusion head, the cutting surface underside and/or the cutting surface upper side is provided with at least two cutting surface sections, wherein the first cutting surface section is adjacent to the cutting edge and the second cutting surface section is not adjacent to the cutting edge.

In a preferred embodiment, at least one of the cutting surfaces, i.e., the cutting surface underside and/or the cutting surface upper side, may have different surface sections with different cutting angles. In this way, the cutting surface profile can be further varied, whereby a cutting surface section adjacent to a cutting edge can have a steeper or flatter angle in contrast to a cutting surface section behind it which is not adjacent to the cutting edge.

In another preferred embodiment, the blade element may be designed to have a curved or approximately curved cutting surface profile by means of several cutting surface sections.

According to a preferred embodiment of the extrusion head, the material feed unit has at least one feed line for the at least one extrusion material, wherein, in the state of the at least one blade element fixed to or in the material feed unit, the at least one feed line extends within the material feed unit up to a region in front of, in particular up to, the at least one blade element.

According to a preferred embodiment of the extrusion head, in the state of the at least one blade element fixed to or in the material feed unit, the feed line ends in a region between the blade element underside and the blade element upper side.

In an embodiment in which the feed line extends to the blade element and/or to a region between the blade element underside and the blade element upper side, the distance over which the extrusion material is not guided, or at least not guided from all sides of the circumference of the extrusion material, is kept to a minimum. This also minimizes the risk of deformation of the extrusion material away from the actual cut. Particularly in cases where the extrusion material is in the form of a filament, deformation of the extrusion material, in particular bending, represents an increased risk with regard to the process reliability of the cutting and further processing of the extrusion material.

According to a preferred embodiment of the extrusion head, the feed line is designed to have at least one guide recess which extends to the separating device and through which the extrusion material is at least partially exposed.

In a preferred embodiment, the feed line has at least one guide recess which can extend to an area in front of the separating device and through which the extrusion material is at least partially exposed.

According to a preferred embodiment of the extrusion head, the feed line has at least one projection, wherein, in the state of the at least one blade element fixed to or in the material feed unit, the at least one projection protrudes into a region between the blade element underside and the blade element upper side, wherein two projections are preferably provided and, in the state of the at least one blade element fixed to or in the material feed unit, the two projections form a guide recess, in particular a groove, preferably a transverse groove, in a region between the blade element underside and the blade element upper side.

With the aid of one or more projections of the feed line, the extrusion material can be guided from at least one or more sides into a region between the blade element underside and the blade element upper side. In a preferred embodiment, it may further be provided that, due to the shape of the at least one projection and/or the shape of the at least one projection surface facing the extrusion material, the extrusion material is guided almost to the cutting edge.

According to a preferred embodiment of the extrusion head, the feed line is present as a separate component within the material feed unit or is a component of the material feed unit.

In a preferred embodiment, the feed line may be made of thermally treated metals, preferably tempered, hardened or nitrided steel, and/or partly of at least one sintered material, preferably tungsten carbide or ceramic, and/or may be coated, preferably with a tungsten sulfide coating. These materials are wear-resistant materials and/or coatings whose use may be particularly advantageous for components subject to high stress, such as the feed line.

According to a preferred embodiment of the extrusion head, at least one conveying device of the material feed unit is provided for feeding the at least one extrusion material, wherein the at least one conveying device is designed to return the at least one extrusion material, preferably cut through, at least partially within the material feed unit.

A conveying device that can move the extrusion material both forwards and backwards, in other words, that can not only extrude the extrusion material but also return it, makes it possible to straighten the extrusion material by pulling it back into the feed line. This is particularly useful if, despite everything, slight deformation of the extrusion material occurs away from the cut.

According to a preferred embodiment of the extrusion head, the at least one displacement unit has at least one receiving device, preferably at least two receiving devices, particularly preferably one receiving device for each liquefying assemblies.

In a preferred embodiment, the at least one receiving device of the at least one displacement unit may be formed on the drive wheel of the at least one displacement unit for displacing the displacement unit relative to the material feed unit on the side facing the material feed unit, preferably by means of countersunk holes.

In a preferred embodiment, the at least two receiving devices of the at least one displacement unit may be formed on the at least two transfer lines, in particular heat break lines, on the side facing the material feed unit, preferably by means of countersunk holes.

In a preferred embodiment, the at least one receiving device may be present as a separate component within the displacement unit or may be a component of the displacement unit.

In a preferred embodiment, the at least one receiving device on the side facing the material feed unit, preferably on and/or within the drive wheel, may be designed as a flat plate, as a flat ring or as a sleeve with preferably a countersunk hole.

In a preferred embodiment, the at least one receiving device may consist of at least one thermally treated metal, preferably of tempered, hardened and/or nitrided steel, and/or partly of at least one sintered material, preferably tungsten carbide or ceramic, and/or may be coated, preferably with a tungsten sulfide coating.

According to a preferred embodiment of the extrusion head, at least one cooling device is provided for cooling the at least one displacement unit and/or the at least one extrusion material and/or the separating device and/or the at least one blade element and/or the at least one conveying device and/or the at least one extrusion actuator and/or the displacement actuator and/or the at least one extrusion material, at least one bearing and/or at least one seal and/or at least one convection shield.

An actuator is a component or mechanism for converting energy, for example electrical energy or pressure energy, into motion, for example kinetic energy, and can in particular be designed as a motor, particularly preferably as an electric motor.

A cooling device may be provided so that the extrusion material can always be cut in a solid state, preferably at a temperature below the melting temperature, the softening temperature or the glass transition temperature, under high nozzle temperatures and processing temperatures, and can be introduced into one of the liquefying assemblies in a process-reliable manner. This can be particularly useful if heat, for example generated by the heating blocks of the liquefying assemblies, migrates upwards to the severing point as a result of diffusion and/or conduction and/or convection, particularly along the extrusion material. The extrusion material is heated by the nozzles via the liquefying assemblies to the severing point and thus softened, which can cause cobweb-like thread formation when the extrusion material is cut or severed.

According to a preferred embodiment of the extrusion head, the at least one cooling device is part of the material feed unit and/or the displacement unit.

According to a preferred embodiment of the extrusion head, the at least one cooling device has one or more bores and/or grooves, in particular straight and/or curved grooves, and/or channels, in particular straight and/or curved channels, within the material feed unit and/or the displacement unit.

According to a preferred embodiment of the extrusion head, the at least one cooling device has one or more coolant interfaces and/or cooling rotary feedthroughs.

Usually, two coolant interfaces are provided for supplying coolant, one for supplying and one for removing the coolant. Any number of coolant interfaces are possible, which can form either one cooling circuit or several cooling circuits.

In a preferred embodiment, the at least one displacement unit may be designed as cooling rotary feedthroughs.

In a preferred embodiment, at least one of the existing coolant interfaces may be arranged within the displacement unit.

In a preferred embodiment, one or more supply lines of the at least one coolant interface arranged within the displacement unit may be provided so that they run at least partially within the displacement unit essentially parallel to the axis of rotation of the displacement unit.

Preferred embodiments of the extrusion head can advantageously, in particular through the use of a cable feed-through designed as a slip ring and/or a distributor and/or a cooling block designed as a cooling rotary feed-through, allow endless rotation of the displacement unit without causing failure of the lines, for example by tearing off the lines.

If the material feed unit is essentially rectangular in shape, a cooling device with four bores may be provided, for example, each of which is sealed to the outside by sealing means. This creates a rectangular cooling path which can be connected to a coolant interface.

If the displacement unit is essentially hexagonal in shape, a cooling device with six holes can be provided, for example, each of which is sealed to the outside by a closure. This creates a hexagonal cooling path that can be connected to a coolant interface.

According to a preferred embodiment of the extrusion head, the at least one cooling device is arranged at least partially in the area after, preferably directly after, the cutting point of the at least one extrusion material.

According to a preferred embodiment of the extrusion head, the at least one cooling device cools by means of a coolant, the coolant preferably being gaseous and/or liquid.

According to a preferred embodiment of the extrusion head, the at least one cooling device is designed to form a continuous cooling loop, preferably with the continuous cooling loop passing through both the material feed unit and the displacement unit.

According to a preferred embodiment of the extrusion head, the separating device with the at least one blade element is a component of the material feed unit or is connected to the material feed unit, and the at least one cooling device is a component of the material feed unit or is connected to the material feed unit. According to a preferred embodiment of the extrusion head, the at least one displacement unit is rotatable, in particular rotatable as a turret head, and the extrusion head is tiltable or tilted, preferably with respect to the longitudinal axis of the extrusion head.

The longitudinal axis of the extrusion head is understood here to be an imaginary axis that runs essentially from the upper side of the support bracket to the underside of the support bracket. The underside of the support bracket is the side facing the displacement unit and the upper side of the support bracket is the side opposite the underside. In other words, the longitudinal axis can also be referred to as the applicate in the direction of which the height of the support bracket can be defined. In other words, the longitudinal axis can be parallel to the Z-axis in the Cartesian coordinate system or to the Z-axis in FIGS. 1 to 10.

By designing the displacement unit as a rotatable part, in particular a rotatable turret, it is particularly easy, inexpensive, and space-saving to pass the displacement unit past the separating device with virtually no gaps and/or to change the liquefying assemblies.

According to a preferred embodiment of the extrusion head, the at least one displacement unit can be rotated in two directions in one plane and the extrusion head can be tilted in at least two directions starting from a vertical starting position.

The vertical starting position is understood to be the position of the extrusion head shown in FIGS. 1 to 3, 28, and 34. In the vertical starting position, the axis of rotation of the displacement unit and the longitudinal axis of the extrusion head are parallel to each other. In other words, the axis of rotation of the displacement unit can be orthogonal to the horizontal upper or lower side of the support bracket. In other words, the tilt angle of the tilting actuator can be set to 0°. In other words, all nozzles of the liquefying assemblies can lie in a horizontal plane.

In a preferred embodiment, the displacement unit can be rotatable relative to the material feed unit, with the axis of rotation of the displacement unit being parallel to the longitudinal axis of the extrusion head or, in other words, parallel to the Z-axis.

In a preferred embodiment, the extrusion head is tiltable relative to a part to which the extrusion head is attached, in particular relative to the support bracket, wherein the tilt axis of the extrusion head is transverse, preferably orthogonal, to the longitudinal axis of the extrusion head or, in other words, transverse, preferably orthogonal, to the Z-axis.

According to a preferred embodiment of the extrusion head, the extrusion head is tiltable at least in one plane, in particular with respect to the longitudinal axis of the extrusion head to two sides within a plane.

In a preferred embodiment of the extrusion head, the extrusion head can be connected to a support bracket by means of a tilting shaft, in particular with a key connection and a nut, and can be tilted by means of a tilting actuator, preferably relative to the support bracket, preferably whereby the extrusion head can be removed as a complete unit from the support bracket, preferably from the tilting shaft, by loosening the slot nut.

In a preferred embodiment of the extrusion head, the tilting shaft may be provided as a component of the tilting actuator, in particular of an electric motor, and/or may be connected or connectable thereto.

In a preferred embodiment of the extrusion head, the support bracket may be provided with an energy transmission device, in particular a belt drive, spur gear, planetary gear or worm gear, wherein the tilting shaft and the tilting actuator may be connected to the energy transmission device.

In a preferred embodiment of the extrusion head, the tilt angle of the extrusion head, at least in one plane, in particular the angle of rotation of the tilting shaft about its axis of rotation, may be adjustable discretely and/or continuously, preferably by adjusting screws as an adjustable stop for the inclination shaft.

In a preferred embodiment of the extrusion head, the support bracket may be connected to a moving system or provided as a component of the moving system, preferably in order to move the extrusion head in at least one direction.

In a preferred embodiment of the extrusion head, the support bracket may have a spindle nut or may be provided as a component of the support bracket, wherein the spindle nut may be connected to a threaded spindle, in particular of the moving system, preferably in order to move the extrusion head in at least one direction.

According to a preferred embodiment of the extrusion head, the displacement unit has at least two, preferably six, liquefying assemblies, wherein a first extrusion material can be extruded through a first set of the existing liquefying assemblies and a second extrusion material can be extruded through a second set of the existing liquefying assemblies.

In a preferred embodiment, the displacement unit may comprise six liquefying assemblies, wherein three liquefying assemblies may comprise the first set and the remaining three liquefying assemblies may comprise the second set.

In another preferred embodiment, the displacement unit may have a different number of liquefying assemblies than specified in the previous embodiments.

In another preferred embodiment, the liquefying assemblies of the first set may be arranged directly adjacent to one another and the liquefying assemblies of the second set may be arranged directly adjacent to one another.

According to a preferred embodiment of the extrusion head, the at least two liquefying assemblies have nozzle channels, wherein the at least two liquefying assemblies or the nozzle channels are tilted relative to each other and/or to an axis of rotation of the displacement unit.

According to a preferred embodiment of the extrusion head, at least one locking means is provided, wherein at least one position of the displacement unit relative to the material feed unit can be determined by the at least one locking means.

In a preferred embodiment, the at least one locking means may be mechanically and/or electromechanically and/or pneumatically and/or hydraulically and/or electromagnetically operable.

In a preferred embodiment, a locking recess may be provided for each locking means.

In a preferred embodiment, the at least one locking means may be designed to be releasably lockable.

In a preferred embodiment, the at least one locking means is designed as a spring-loaded pressure piece, in particular a ball pressure piece, and in combination with at least one locking recess, preferably one countersunk hole for each nozzle and/or each nozzle of a set. The at least one locking means can be used to fix at least one position of the displacement unit relative to the material feed unit, preferably releasably.

According to a preferred embodiment of the extrusion head, at least one stop is provided, whereby the rotatability of the displacement unit in at least one direction, preferably in two directions, is limited by the at least one stop, preferably in combination with at least one stop guide. The at least one stop can perform a protective function for the lines used and/or against any contamination.

In a preferred embodiment, at least one sensor can be provided for detecting the rotational position of the displacement unit relative to the material feed unit.

In a preferred embodiment, the at least one sensor for detecting the rotational position of the displacement unit relative to the material feed unit may be an absolute rotary encoder or an incremental rotary encoder and/or a Hall sensor, preferably with a magnetic tape, and/or an inductive sensor, preferably with a pole wheel, and/or an electro-optical sensor, preferably with a line disc.

In a preferred embodiment, the at least one sensor for detecting the rotational position of the displacement unit relative to the material feed unit may be connected or connectable to the displacement actuator and/or to the transmission wheel and/or to the drive wheel.

According to a preferred embodiment of the extrusion head, the material feed unit and/or the displacement unit has a cable feed-through, in particular an electrical rotary feed-through and/or a cable gland.

In a preferred embodiment, the material feed unit and/or the displacement unit may have a cable gland with preferably a seal and/or a sealing insert and/or an electrical rotary feedthrough designed as a sliding ring with preferably a seal.

According to a preferred embodiment of the extrusion head, a platform is provided on which the product can be finished by means of additive manufacturing.

In a preferred embodiment, the platform may be designed as a rotary table in order to provide an additional (e.g., fifth) axis of rotation, in particular the C axis, for 5-axis additive manufacturing, in order to preferably produce complex geometries with undercuts without the use of support structures, wherein the fourth axis, in particular the A axis or B axis, is realized by the tiltable extrusion head.

According to a preferred embodiment of the extrusion head, the extrusion head is arranged within a mounting structure, wherein a convection shield is provided between the extrusion head and the mounting structure, and/or the mounting structure is arranged within a moving system, wherein a convection shield is provided between the mounting structure and the moving system, preferably at least one moving device of the moving system.

The convection shield may be one-piece or multi-piece. Several convection shields that are not directly connected to each other may also be provided, each convection shield being one-piece or multi-piece when viewed individually. If several convection shields are provided, these may also be referred to collectively as a convection shield.

In a preferred embodiment, the moving system may comprise at least one frame and at least one drive for moving the mounting structure.

According to a preferred embodiment of the extrusion head, the convection shield is arranged between the extrusion head and the mounting structure in such a way that, inside and/or outside the mounting structure, in particular inside an imaginary infinite volume of the projected base area of the assembly structure, two areas are provided, wherein the material feed unit is essentially arranged in one of the two areas and the displacement unit is essentially arranged in the other of the two areas, and/or the convection shield is arranged between the mounting structure and the moving system, preferably at least one moving device of the moving system, in such a way that two areas are present within the moving system, wherein the material feed unit is essentially arranged in one of the two areas and the displacement unit is essentially arranged in the other of the two areas.

According to a preferred embodiment of the extrusion head, the convection shield is connected or connectable to the extrusion head and the mounting structure and/or to the mounting structure and the moving system, preferably at least one moving device of the moving system, preferably in a non-destructive manner, by one or more convection shield connection devices.

According to a preferred embodiment of the extrusion head, the convection shield is designed to be flexibly deformable due to its shape and/or material.

According to a preferred embodiment of the extrusion head, the convection shield has at least one separating means, preferably a separating hose and/or a separating membrane and/or a bellows, preferably flat, conical, pyramidal, particularly preferably pyramid-shaped stepped, and/or a pleated roof cover, preferably a multi-part pleated roof cover.

According to a preferred embodiment of the extrusion head, the convection shield, in particular the separating means, consists at least partially of silicate fabric and/or at least partially of aramid fabric, preferably of aluminized preox-para-aramid fabric, and/or at least partly of rubber, preferably fluorinated rubber (FKM) or silicone rubber (HTV), and/or is partly coated with silicone and/or polytetrafluoroethylene.

In a preferred embodiment, the convection shield, in particular the folding roof cover, may consist of several elements, at least partially made of coated plastic fabric, in particular sewn and/or thermally welded and/or bonded, and/or at least one metal.

According to a preferred embodiment of the extrusion head, the convection shield has at least one shaft seal, in particular a radial sealing lip and/or at least one axial sealing lip and/or at least one labyrinth seal, and/or at least one stiffener, in particular in the form of a stiffening ring.

In a preferred embodiment, the at least one shaft seal is an integral part of the convection shield or a separate component that can be attached thereto.

According to a preferred embodiment of the extrusion head, at least one measuring device is provided, wherein the at least one measuring device may be a mechanical, thermoelectric, resistive, piezoelectric, capacitive, inductive, optical, acoustic, and/or magnetic measuring device.

In a preferred embodiment, an arrangement may be provided, wherein the arrangement consists of at least the following arrangement components: an extrusion head and a convection shield and a mounting structure, wherein a shielding, in particular a thermal and essentially dense shielding, is provided by the interconnected arrangement components, wherein the shielding, in particular the thermal and essentially dense shielding, shield divides the operating space into two areas, preferably wherein the arrangement additionally has a moving system.

In a preferred embodiment, the shielding is constructed by a mounting structure, the material feed unit, the displacement unit and at least one convection shield between the mounting structure and the extrusion head, in particular the material feed unit. It may be preferred that a moving system and a convection shield between the mounting structure and the moving system also form part of the shielding.

In a particularly preferred embodiment, the shielding is at least partially formed by the displacement unit receiving block of the material feed unit and by bearings between the material feed unit and the displacement unit, in particular roller/slide bearings with seals, as well as by the cooling block and/or by the casing and/or by a part of the existing seals and/or cable bushings, preferably cable glands and/or electrical rotary feedthroughs designed as slip rings, which is constructed on the displacement unit.

In a preferred embodiment, the displacement unit and the separating device can be arranged within the displacement unit receiving block, wherein the drive wheel and/or the at least one receiving device and the separating device and/or the at least one blade element can be provided in a recess, which is referred to below as the separating chamber, of the displacement unit receiving block, wherein this separating chamber can be closed at the bottom by at least part of the shielding arrangement and can be at least partially open at the top or closed with the exception of the feed line.

This advantageously prevents and/or reduces convection of waste heat from the drives from above to the severing point.

Furthermore, protection is sought for a method and/or use for manufacturing a product with an extrusion head according to the invention.

According to a preferred embodiment of the method, by tilting the extrusion head, the nozzle of one of the existing liquefying assemblies is moved into a position below the remaining nozzles of the existing liquefying assemblies.

According to a preferred embodiment of the method, by rotating the displacement unit while the extrusion head is tilted, the nozzle of one of the existing liquefying assemblies is moved into a position below the remaining nozzles of the existing liquefying assemblies.

According to a preferred embodiment of the method, the displacement unit comprises at least one set of at least two liquefying assemblies, wherein the at least two liquefying assemblies of the set have two different nominal widths of the nozzles, and by rotating the displacement unit, preferably with the extrusion head tilted, a product is manufactured with different degrees of accuracy due to the nominal widths of the nozzles of the at least two liquefying assemblies.

According to a preferred embodiment of the method, by tilting the extrusion head from a vertical starting position in at least two directions, a material change between at least two different extrusion materials takes place.

According to a preferred embodiment of the method, undercuts are taken into account in a product to be manufactured and that the product is built up layer by layer with at least one extrusion material by tilting the extrusion head and/or by rotating the displacement unit, wherein, during the layer-by-layer build-up by tilting the extrusion head and/or by rotating the displacement unit, a support structure is additionally built up with at least one other extrusion material to support the undercuts of the product.

### BRIEF DESCRIPTION OF THE DRAWINGS

Further details and advantages of the invention will be explained in more detail below with reference to the drawings, in which:

FIGS. 1 to 3: are various perspective views of an extrusion head according to the invention;

FIG. 4: is a front view of the extrusion head from FIG. 1 with a partial section;

FIG. 5: is a detailed view of a first separating device and a first feed line based on detail I from FIG. 4;

FIG. 6: is a sectional view of the first separating device and the first feed line from FIG. 5 based on the sectional plane B-B from FIG. 5;

FIG. 7: is a sectional view of a second separating device and a second feed line based on the sectional plane B-B from FIG. 5;

FIG. 8: is a sectional view of a third separating device based on the sectional plane B-B from FIG. 5;

FIG. 9: is a sectional view of a fourth separating device based on the sectional plane B-B from FIG. 5;

FIG. 10: is a sectional view of a fifth separating device based on the sectional plane B-B from FIG. 5;

FIG. 11: is a perspective view of a feed line from FIG. 4;

FIGS. 12 to 21: show various design variants of blade elements;

FIG. 22: is a side view of the extrusion head from FIG. 1 with a first variant of a cooling device, shown as a sectional view based on section A-A;

FIG. 23: is a side view of the extrusion head with a second variant of a cooling device, shown as a sectional view;

FIG. 24: is a side view of the extrusion head with a third variant of a cooling device, shown as a sectional view;

FIG. 25: is a perspective view of the displacement unit from FIG. 1 without liquefying assemblies;

FIG. 26: is a perspective view of the displacement unit from FIG. 1 with liquefying assemblies;

FIG. 27: is a detailed view of a nozzle of a liquefying assembly of an extrusion head based on detail II from FIG. 4;

FIG. 28: is a front view of the extrusion head from FIG. 1, installed in an assembly structure, shown with a partially cut-away panel of the assembly structure;

FIG. 29 to 32: show various design variants of convection shield end caps based on detail III from FIG. 28;

FIG. 33 to 35: show various positions of the tiltable extrusion head from FIG. 1;

FIG. 36: is a perspective view of the extrusion head with the mounting structure from FIG. 35, implemented in a displacement unit.

FIG. 37: shows an arrangement of the extrusion head within the mounting structure and a first platform;

FIG. 38: shows an arrangement of the extrusion head within the mounting structure and a second platform; and

FIG. 39: is an exploded view of the support bracket, the tilting actuator, the tilting shaft, and the displacement unit.

### DETAILED DESCRIPTION OF THE INVENTION

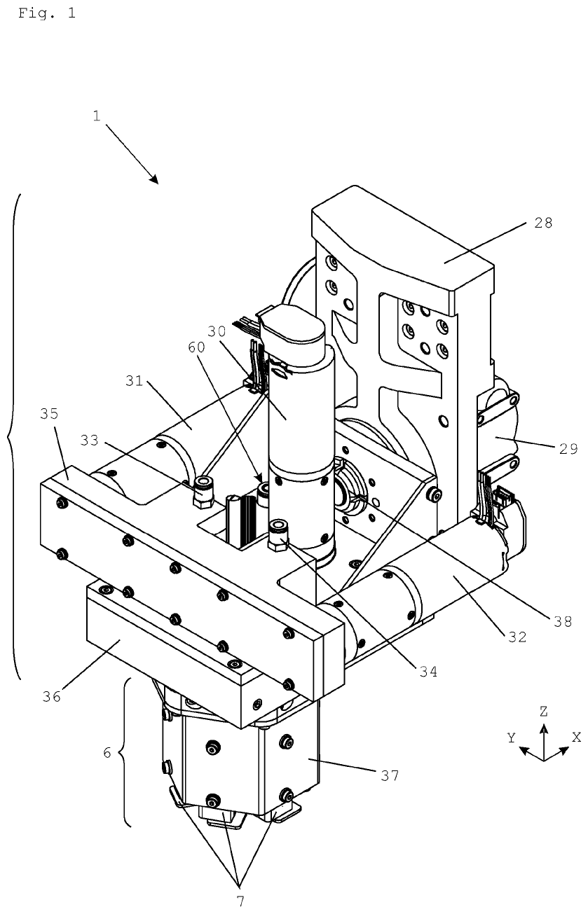

FIGS. 1 to 3 show different perspective views of an extrusion head 1 according to the invention.

In FIG. 1, it can be clearly seen that the extrusion head 1 consists of the material feed unit 2 and the displacement unit 6 arranged below it.

The material feed unit 2 is primarily used to feed and/or receive at least one extrusion material from a material reservoir and may also include other functions and components required for this purpose.

In this embodiment, two extrusion materials can be fed independently of each other. For this purpose, the extrusion material, which is preferably in the form of a filament, is introduced into one of the two material receiving nozzles 33 or 34. As shown in FIG. 1, a first extrusion material can be introduced into the first material receiving nozzle 33 and a second extrusion material into the second receiving nozzle 34.

The material receiving nozzles 33 and 34 can be arranged on the upper side of the extrusion block 35, but other positions are also conceivable.

It can also be provided, as shown here, that a separate extrusion actuator 31, 32 is provided for the extrusion materials used.

An actuator may in particular be a motor.

In this embodiment, the extrusion actuator 31 can be used to move the first extrusion material, which is introduced into the extrusion block 35 through the first material receiving nozzle 33, via a system arranged in the extrusion block 35. The first extrusion material can be conveyed from the first material receiving nozzle 33 via the extrusion block 35 and further via the displacement unit receiving block 36 to one of the liquefying assemblies 7. The conveying direction can also be reversed in order to pull the first extrusion material at least partially in the direction of the first material receiving nozzle 33.

The same conveying operation as described above can also be performed with the second extrusion material, which can be introduced into the second material receiving nozzle 34, wherein the second extrusion actuator 32 conveys the second extrusion material within the extrusion block 35 and the displacement unit receiving block 36 into one of the liquefying assemblies 7 or withdraws it in the opposite direction.

The extrusion block 35 can be connected to the two extrusion actuators 31 and 32 and to the displacement unit receiving block 36, as shown in FIG. 1. The displacement unit receiving block 36 can in turn be connected to an displacement actuator 30, wherein the displacement actuator 30 can serve as a drive for moving the displacement unit 6 and preferably has an incremental or absolute rotary encoder. In addition, the displacement unit receiving block 36 can be connected to the displacement unit 6, wherein the displacement unit 6 is movably mounted in the displacement unit mounting block 36. As shown here, the displacement unit 6 can be mounted so as to be rotatable about the Z-axis, such rotational movement being brought about by the displacement actuator 30.

In this embodiment, the displacement unit 6 has six liquefying assemblies 7, only three of which are visible in FIG. 1. The liquefying assemblies 7 can be covered with a casing 37 and/or attached to a casing 37, as shown here. The other components of the displacement unit 6 will be explained in more detail later.

The displacement unit receiving block 36 may, as shown here, have one or more coolant interfaces 60. These can serve as inlet and/or outlet points for a coolant to cool the material feed unit 2. Preferably, the coolant interface 60 can be designed as a push-fit connection.

The displacement unit receiving block 36 is in contact with a tilting shaft 38, via which the displacement unit receiving block 36 can be connected to a support bracket 28 and inclined via a tilting actuator 29. The support bracket 28 can in turn be implemented in a displacement unit in order to move the extrusion head 1 in at least one direction. This will be explained in more detail later.

The tilting shaft 38 can be designed, as shown here, so that the extrusion head 1 can be moved as a whole with the exception of the support bracket 28 and the tilting actuator 29. In the case shown in FIG. 1, the extrusion head 1 can be tilted relative to the support bracket 28. The tilting actuator 29 can serve as the drive for this movement. In this case, the rotational movement of the extrusion head 1 is around the X-axis.

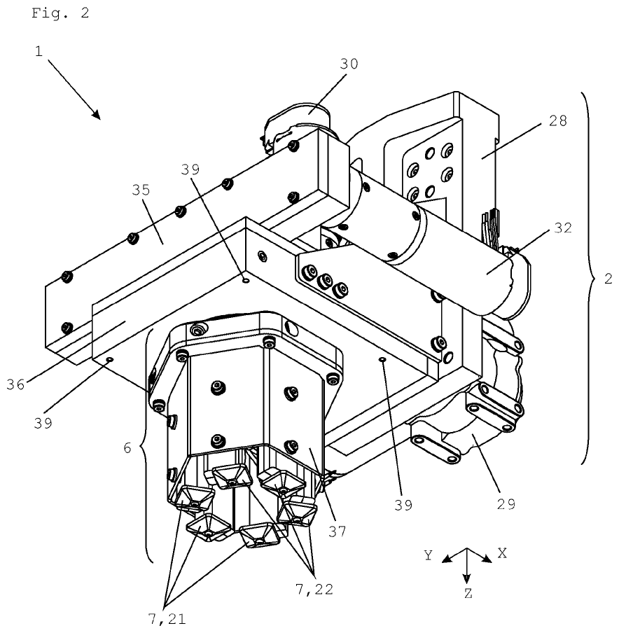

FIG. 2 shows the extrusion head 1 from FIG. 1 from a different perspective. The displacement unit 6 is particularly easy to see here. This illustration shows all six liquefying assemblies 7, which are arranged radially inside the casing 37.

As shown in FIG. 2, convection shield connecting devices 39 can be provided to attach a convection shield to the displacement unit receiving block 36. For example, a pleated bag can be connected to the displacement unit mounting block 36 via screw connections.

FIG. 3 shows the extrusion head 1 from FIG. 1 from a different perspective view. One of the two conveying devices 16, 40 and a recess for the tilting shaft 38 are clearly visible.

The conveying devices 16, 40 can include at least two feed wheels 41, between which the at least one extrusion material can be located. The at least one extrusion material can be moved by the rotation of the feed wheels 41 of the conveying device 16, 40. A detailed description follows later.

As already shown in FIGS. 1 and 2, FIG. 3 also shows how the displacement unit receiving block 36 can be connected to a rear wall 43 via two triangular side walls 42, wherein the rear wall 43 has a recess for the tilting shaft 38. In addition, particularly for better absorption of shear forces, sleeves and/or dowel pins may be provided in opposite recesses between the rear wall 43 and the displacement unit receiving block 36. The tilting shaft 38, which is not shown in FIG. 3, allows the rear wall 43 to be connected to the support bracket 28, which is also no longer shown here, and to be actuated by the tilting actuator 29, which is also no longer shown here, so that the extrusion head can be rotated relative to the support bracket 28. In this case, this rotational movement takes place around the X-axis.

Furthermore, lines 44 may be provided which can serve as electrical lines and/or cooling lines for the displacement unit 6. For example, the lines 44 can be used as a power supply and/or as a coolant supply and/or as signal transmission paths for measuring devices such as temperature sensors.

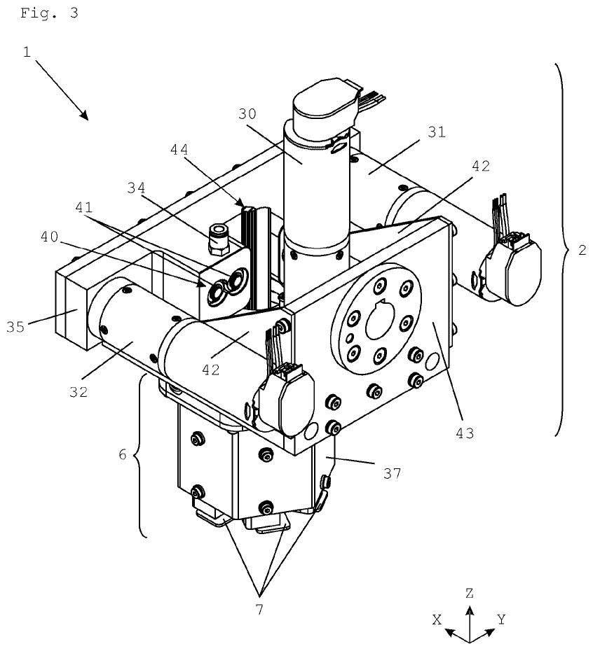

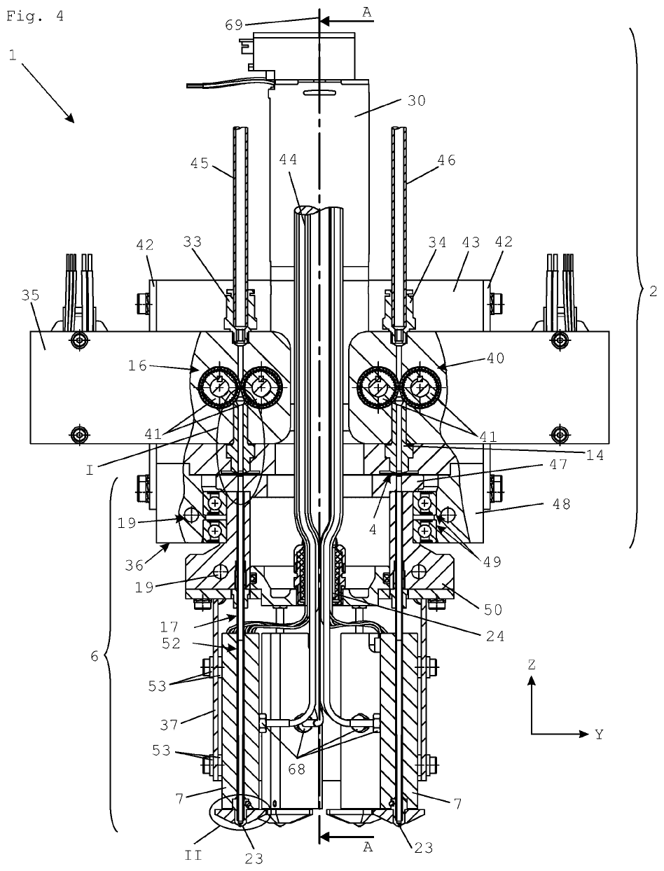

FIG. 4 shows a front view of the extrusion head 1 from FIGS. 1 to 3 with a partial section. In this view, the section plane of the partial section runs along the two guide paths of the two extrusion materials, starting at the material feed hoses 45, 46, via the two material receiving nozzles 33, 34, the extrusion block 35, the displacement unit receiving block 36 and the liquefying assemblies 7, and ending at the nozzle channels 23. In other words, the section plane lies in the YZ plane at the level of the extrusion material guide.

As in the preceding FIGS. 1 to 3, the side walls 42, which are connected on one side to the rear wall 43 and on the other side to the displacement unit receiving block 36, can be seen. The displacement unit receiving block 36 is also connected to the extrusion block 35.

The extrusion block can contain at least one conveying device 16, 40 for at least one extrusion material. In the embodiment shown here, the two conveying devices 16 and 40 are provided to move two extrusion materials independently of each other. In other embodiments, more or fewer conveying devices and/or more or fewer extrusion materials may be provided.

The extrusion head is described below using a first guide path for a first extrusion material. However, it should be noted that the second guide path shown here can be described in the same way and that the description applicable to the first guide path may apply in general but not necessarily to other guide paths. This means that guide paths for extrusion materials as provided in FIG. 4 may be provided, but are not limited to the embodiment shown.

The first guide path begins at the first material feed hose 45, into which the first extrusion material can be introduced. The first material feed hose is connected to the first material receiving nozzle 33, which in turn is connected to the extrusion block 35. The first material receiving nozzle 33 can preferably be a push-fit connection. The first guide path continues through the extrusion block 35 to the first conveying device 16, which has two feed wheels 41. The feed wheels 41 can be driven by a first extrusion actuator 31. The rotating feed wheels 41 can either convey the first extrusion material further in the direction of the displacement unit 6 or back in the opposite direction. Along the first guide path, between the feed wheels 41 and the displacement unit 6, specifically the drive wheel 47, an introduction line 14 and a separating device 4 are provided, which will be explained in more detail later. The first guide path passes through the displacement unit 6, starting with the drive wheel 47, continuing through a transfer line 17, in particular a heat break line, in the cooling block 50 of the displacement unit 6, wherein the transfer line 17, in particular the heat break line, protrudes beyond the cooling block 50 of the displacement unit 6 and extends into one of the liquefying assemblies 7. A nozzle pipe 52 is connected directly to the end of the transfer line 17, in particular the heat break line, in one of the liquefying assemblies 7, which continues the first guide path to the nozzle channel 23, where it ends.

In a preferred embodiment, as shown in FIG. 4, the transfer line 17, in particular the heat break line, can run from the upper end of the cooling block 50 into one of the existing liquefying assemblies 7. In a preferred embodiment, the transfer line 17 between the cooling block 50 and the corresponding liquefying assembly 7 can form a section in which the transfer line 17, in particular the heat break line, is free-standing. This means that the transfer line 17, in particular the heat break line, can be installed partially free-standing or, in other words, partially without contact with other components. This has the advantage that the heat generated by the liquefying assemblies 7 can thus migrate more difficultly to the cooling block 50. Apart from the convection of the ambient air, heat can then only migrate to the cooling block 50 via the thin components such as the transfer line 17, in particular the heat break line, preferably made of a material with a low heat transfer coefficient, particularly preferably stainless steel, whereby a lower heat transfer can be achieved.

In a preferred embodiment, it may be provided that a partially free-standing or, in other words, partially contact-free section of the transfer line 17, in particular the heat break line, can be air-cooled, wherein the air cooling, preferably in an area at least partially separated from the installation space to maintain the thermal homogeneity of the installation space air, can be pressureless or with compressed air.

Cooling devices 19 can be provided both in the material feed unit 2 and in the displacement unit 6. As shown in this embodiment, these cooling devices 19 can be provided specifically in the displacement unit receiving block 36, preferably in the heat sink 48, as well as in the cooling block 50 of the displacement unit 6.

The cooling devices 19 can be holes through which the coolant flows, as shown in FIG. 4.

The displacement unit 6 can be in contact with bearings 49 by means of the drive wheel 47 and the cooling block 50 of the displacement unit 6, which in turn are in contact with the material feed unit 2, specifically in FIG. 4 with the displacement unit receiving block 36. In this way, the displacement unit 6 can be rotatably mounted in the material feed unit 2, specifically in the displacement unit receiving block 36.

Lines 44 may be provided between the two guide paths, wherein the lines 44 may be provided for the supply and removal of cooling media and/or as a power connection. As shown in FIG. 4, the lines 44 may be, among other things, power lines for the liquefying assemblies 7 and signal transmission paths for measuring devices 68, in particular temperature sensors. Before the lines 44 are distributed to the individual liquefying assemblies, they can be routed through a cable feedthrough 24, in particular a cable gland with preferably a seal and/or a sealing insert used as strain relief and/or an electrical rotary feedthrough, for example designed as a slip ring with preferably a seal used as strain relief, torque relief, energy transmission and/or signal transmission.

FIG. 5 shows a detailed view of a first separating device 4 and a first feed line 14 based on the detail I from FIG. 4.

The extrusion material 3 can be moved by the feed wheels 41 as described above. The extrusion material 3 can be conveyed along the feed line 14 to the separating device 4. The extrusion material 3 can then be introduced into a receiving device 18, which in this specific embodiment is designed as a countersunk hole in the drive wheel 47. After being introduced into the receiving device 18, the extrusion material can be transported further so that it is moved by the drive wheel 47 of the displacement unit 6 and further through the transfer line 17, in particular the heat break line, into the cooling block 50 of the displacement unit 6.

In the area where the separating device 4 is provided, the extrusion material 3 can be cut through.

The transfer line 17 can, as shown in FIG. 5, represent a heat break line located in the cooling block 50. In another preferred embodiment, it can also be provided that the transfer line 17 runs completely through the cooling block 50 and the drive wheel 47 of the displacement unit 6. If the transfer line 17 extends to the upper end of the displacement unit 6, specifically to the upper end of the drive wheel 47, the receiving device 18 can be part of the transfer line 17.

The separating device 4 has at least one blade element 5, wherein the at least one blade element 5 is fastened to the material feed unit 2. At least one blade connection device 8 may be provided for fastening the at least one blade element 5, wherein the blade connecting device 8 may be, for example, a screw connection between the blade element 5 and the material feed unit 2.

In FIG. 5, one of the two blade elements 5 is clearly visible. In this embodiment, the blade element 5 is a flat and angular blade. The blade element 5 is arranged in the material feed unit 2 in such a way that the material feed unit 2 and the displacement unit 6 can be guided past each other with approximately no gap.

When the displacement unit 6 is moved by actuating the drive wheel 47, the extrusion material 3 can be fed to the at least one blade element 5 and cut at a severing point. The upper severed end of the extrusion material 3 can then be introduced into one of the existing receiving devices 18 depending on the movement of the displacement unit 6 and thus fed to one of the existing liquefying assemblies.

In order to achieve clean cutting of the extrusion material 3 and/or to prevent bending of the extrusion material 3 during the cutting process, it is advantageous to guide the displacement unit 6 past the material feed unit 2 with approximately no gaps.

It can be clearly seen in FIG. 5 that the feed line 14 is arranged as a separate component in the material feed unit 2 and has two projections 57. These two projections can serve to guide the extrusion material 3 closer to a cutting edge 11 so that bending of the extrusion material 3 during cutting can be avoided.

In an imaginary triangle whose first corner is the center of the axis of rotation of the displacement unit, whose second corner is the center of the cross section of the preferably circular extrusion material 3 above the cutting edge, and whose third corner is the center of the cross section of the, preferably circular, extrusion material 3 below the cutting edge, the extrusion material 3 may bend along the cutting edge during the cutting of the extrusion material 3 due to the cutting rotation performed by the displacement unit 6, whereby the adjacent leg of the imaginary triangle described above is shortened.

As shown here, the feed line 14 protrudes into an effective area of the blade element 5; specifically, the two projections 57 of the feed line 14 protrude into an effective area of the blade element 5. In other words, the feed line 14 ends with the two projections 57 in an area between the blade element underside 55 and the blade element upper side 56.

If the extrusion material 3 bends slightly during the cutting process, the extrusion material 3 can be moved back up again by the feed wheels 41, allowing the extrusion material 3 to realign itself in the feed line 14.

FIG. 6 shows a sectional view of the first separating device 4 and the first feed line 14 from FIG. 5 based on the sectional plane B-B from FIG. 5.

In contrast to the detailed view in FIG. 5, the sectional view based on the sectional plane B-B from FIG. 5 shows that the separating device 4 consists of two individual blade elements 5. Both blade elements 5 are flat and angular blades.

In the section B-B of FIG. 6, one of the two projections 57 is clearly visible. The projection 57 of the feed line 14 shown here protrudes into an imaginary blade element cavity 15 of the separating device 4, wherein the separating device 4 here has two blade elements 5. In this embodiment, the imaginary blade element cavity 15 of the separating device 4 with the two blade elements 5 arranged parallel to each other corresponds to a trapezoidal prism, the trapezoidal cross-section of such a trapezoidal prism being visible in FIG. 6. The surface of the projection 57 visible in FIG. 6 also corresponds to a trapezoidal surface, wherein the trapezoidal surface of the projection 57 is smaller than the trapezoidal cross-section of the prism which describes the imaginary blade element cavity 15 of the separating device 4. The trapezoidal surface of the projection 57 lies between the two blade elements 5 and is limited in each case by one of the cutting surface upper sides 10 of the blade elements 5. The underside of the trapezoidal surface of the projection 57 ends in a region between the lower side 55 of the blade element and the upper side 56 of the blade element. The projections 57 of the feed line 14 reduce the imaginary blade element cavity 15 of the separating device 4, with the two projections 57 delimiting the trapezoidal prism on two sides.

In other embodiments, more or fewer blade elements 5 may be provided. The number and shape of blade elements 5 shown here are not to be understood as limiting.

FIG. 7 shows a sectional view of a second separating device 4 and a second feed line 14 based on the sectional plane B-B from FIG. 5.

In contrast to the embodiment shown in FIG. 6, in FIG. 7 the feed line 14 is not provided as a separate component, but as a continuous guide bore through the extrusion block 35. The projections 57, of which only one is visible in FIG. 7, are also components of the extrusion block 35. The shape and arrangement of the projections 57 correspond to the shape and arrangement shown in FIG. 6. Here too, the projections 57 protrude into an imaginary blade element cavity 15 of the separating device 4 and limit it.

In contrast to FIG. 6, only one blade element 5 is provided here, which is flat and has a round cutting edge 11. The imaginary blade element cavity 15 of the separating device 4 thus corresponds to a truncated cone in this embodiment. For a better illustration of this imaginary blade element cavity 15, specifically the truncated cone, reference is made to FIGS. 16 to 18.

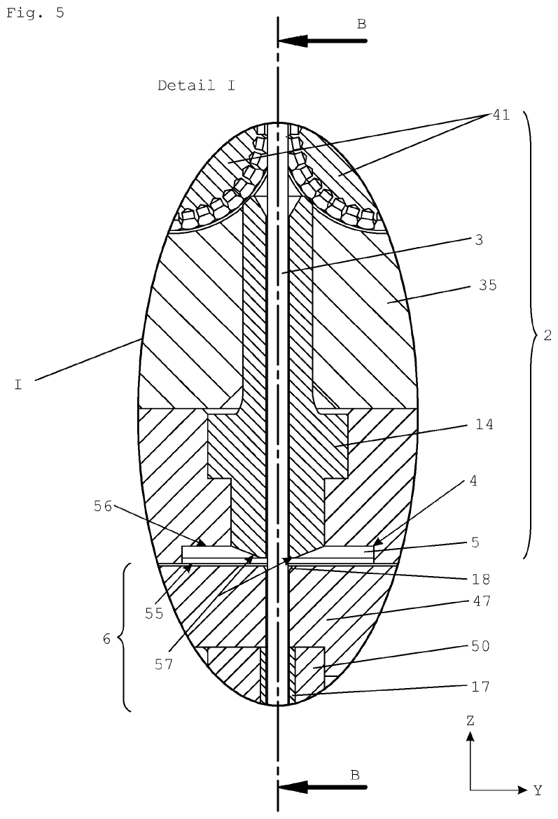

FIG. 8 shows a sectional view of a third separating device 4 based on the sectional plane B-B from FIG. 5;
Unlike in FIG. 7, in FIG. 8 the transverse groove of the projections 57 extends upward in a funnel-like manner, resulting in a guide recess 58, and the funnel tapers into the round through-bore in a long slot-like manner. This allows the extrusion material 3 to move more freely toward the cutting edge, enabling the blade element 5 to penetrate the extrusion material 3 more effectively.

In a preferred embodiment, the receiving device 18 may also be designed as a separate component within the drive wheel 47 of the displacement unit 6. It may be provided that the receiving device 18 may be formed as a flat plate, as a flat ring or as a sleeve with preferably a countersunk bore.

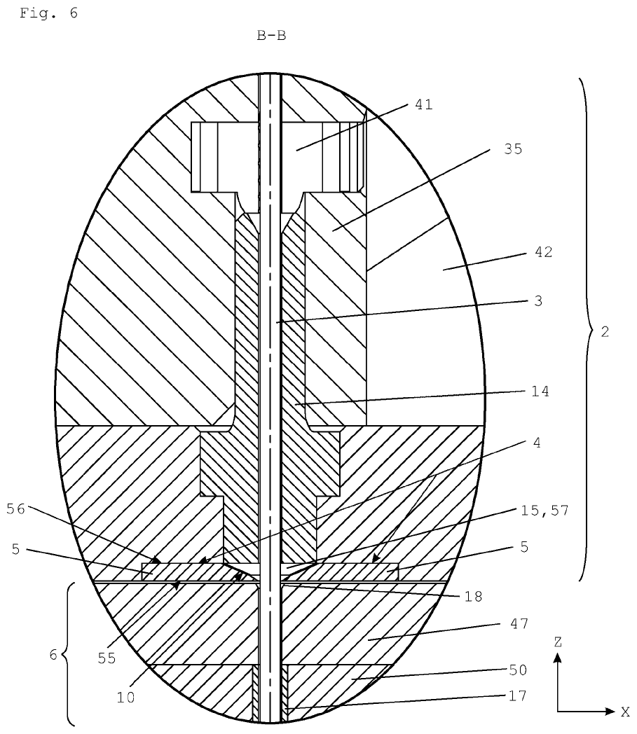

FIG. 9 shows a sectional view of a fourth separating device 4 based on the sectional plane B-B from FIG. 5.

As shown in FIG. 9, the separating device 4 may have only one blade element 5, wherein the blade element may be a blade sleeve.

In this embodiment, the feed line 14 is not a separate component, but is provided as a guide bore in the extrusion block 35.

It may also be provided that the opening of the blade sleeve is of a long slot design or, as described in FIG. 8, that the projections 57 are formed by a component inserted separately into the blade sleeve.

FIG. 10 shows a sectional view of a fifth separating device 4 based on the sectional plane B-B from FIG. 5;
Unlike in FIG. 9, in this view the transfer line 17 is designed such that it runs through both the cooling block 50 and the drive wheel 47 to the upper end of the displacement unit 6, thereby also performing the function of the receiving device 18.

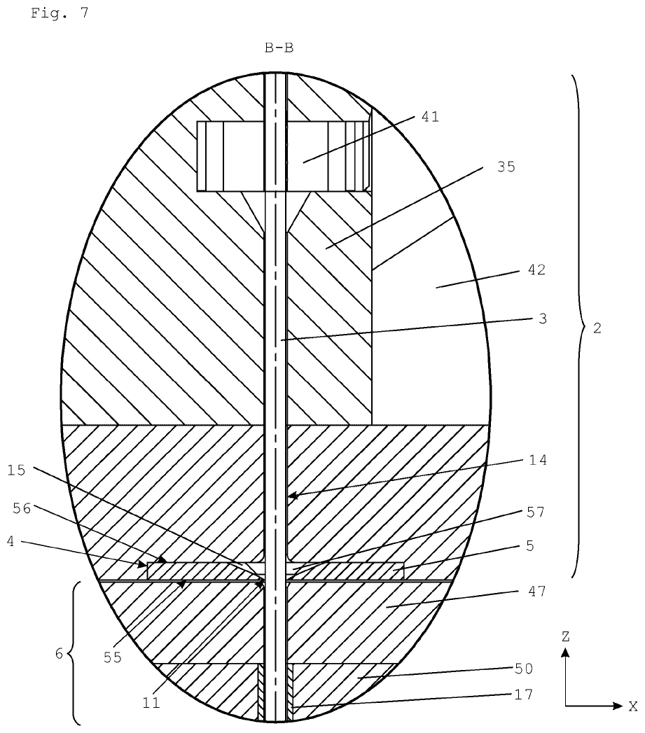

FIG. 11 shows a perspective view of the feed line 14 from FIGS. 4 to 6.

The feed line 14 is an essentially cylindrical component, as shown here in shaft form, with a central through-bore through which the extrusion material 3 can be fed. The feed line 14 has a collar with which the feed line can be arranged in the extrusion block 35.

Furthermore, the feed line 14 preferably has a flat milled section or, for example, a toothed profile on the collar, with which the orientation of the projections 57 can be aligned with the blade element 5.

At one end of the feed line 14 are the two projections 57, which together form a guide recess 58, in this specific case a groove.

With the aid of the projections 57, the extrusion material 3 can be guided closer to the cutting edges 11 of the blade elements 5. This is explained in more detail in FIGS. 5 to 7.

FIGS. 12 to 21 show different design variants of blade elements 5.

FIG. 12 shows a perspective view from above of one of the blade elements 5 from FIGS. 4 to 6. On one side, the blade element 5 has a cutting edge 11. Between the upper side 56 of the blade element and the cutting edge 11, there is a cutting surface upper side 10 which is inclined relative to the upper side 56 of the blade element.

When the blade element 5 is fixed to or in the material feed unit 2, the cutting surface upper side 10 is arranged facing away from the displacement unit 6. The cutting surface upper side 10 facing away from the displacement unit 6 has two surface sections, wherein the first cutting surface section 12 is adjacent to the cutting edge 11 and the second cutting surface section 13 is not adjacent to the cutting edge 11. As shown in FIG. 12, it may be provided that the first cutting surface section 12 forms a different, in particular a larger, angle with the cutting surface underside 9 of the at least one blade element 5 facing the displacement unit 6 than the second cutting surface section 13.

Two parts of a blade connection device 8 can be seen on the blade element upper side 56 of the blade element 5, wherein the blade connecting device 8 can be a screw connection, preferably by means of countersunk screws, between the material feed unit 2 and the blade element 5.

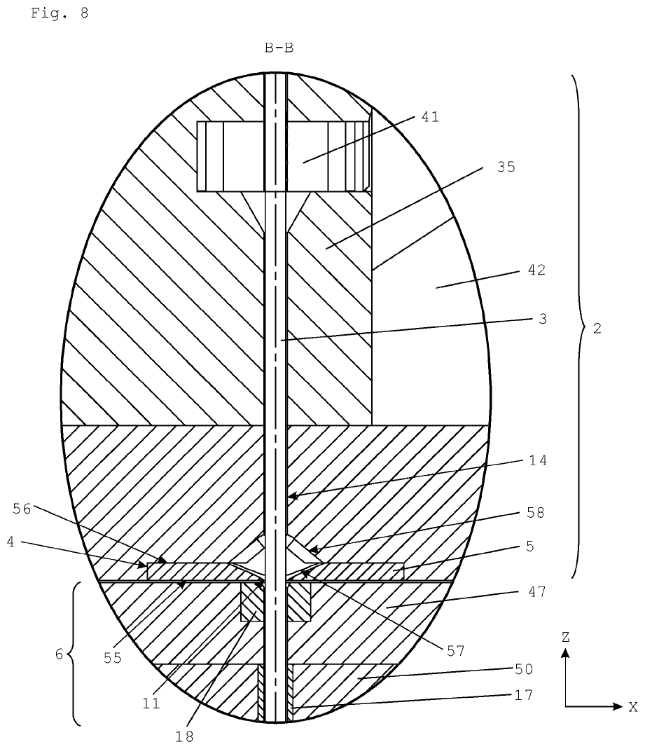

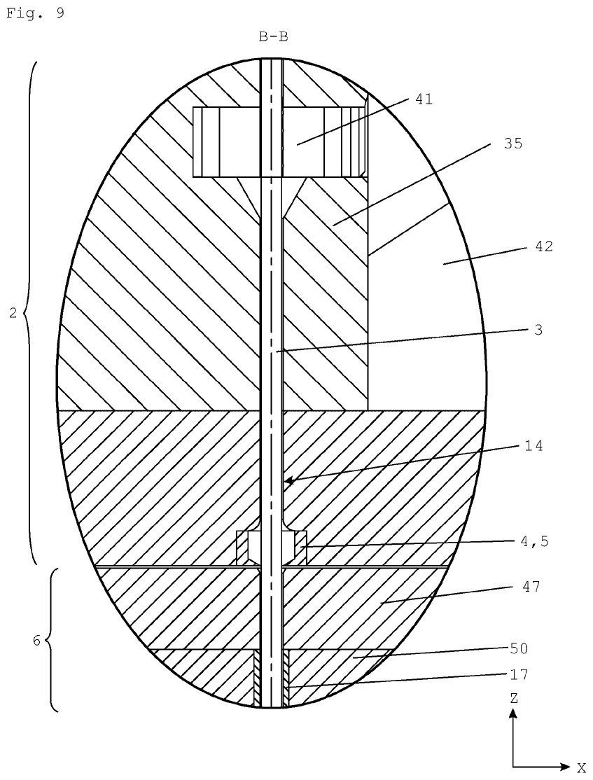

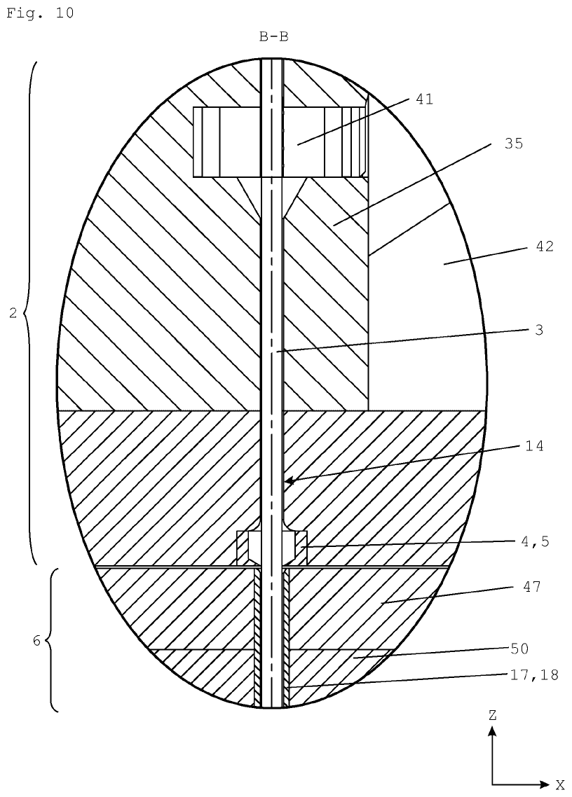

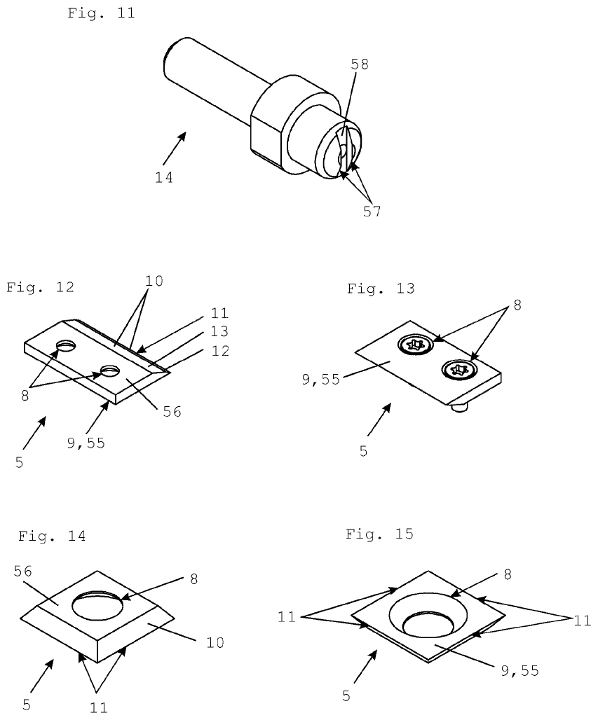

FIG. 13 shows a perspective view from below of the blade element 5 from FIG. 12 with the additional blade connecting devices 8, which are designed here as countersunk screws. On the underside 55 of the blade element, it can be partially seen that countersunk holes are provided which can be connected to the material feed unit 2 by means of the blade connecting devices 8, which are shown here as two countersunk screws.

FIG. 14 shows a perspective view from above of a four-edged blade element 5. This embodiment of a blade element 5 has a square and flat base body, but in contrast to the blade elements 5 already described, four cutting edges 11 are provided here. The number of cutting edges 11 shown here is not to be understood as limiting. Any number of cutting edges per blade element 5 can be provided as desired.

Having more than one cutting edge per blade element 5 can have the advantage that a blade element 5 can be used several times easily as a result of wear and/or damage to a cutting edge 11. To do this, simply loosen the blade connection device 8, reposition the blade element with a new cutting edge 11, and reattach the blade connecting device 8.

FIG. 15 shows a perspective view of the blade element 5 from FIG. 14 from below. The above statements regarding the blade connecting device 8 also apply here.

FIG. 16 shows a perspective view from above of a flat and angular blade element 5 with a round cutting edge 11. As explained above, this embodiment of a blade element 5 forms a truncated cone as an imaginary blade element cavity 15. What has already been said about the blade connecting device 8 also applies here.

FIG. 17 shows a perspective view of the blade element 5 from FIG. 16 from below. What has already been said about the round cutting edge 11 and the blade connecting device 8 also applies here.

FIG. 18 shows a perspective view from above of a flat and round blade element 5 with a round cutting edge 11. The round blade element 5 is circular in shape and shown as a sectional view. The section runs centrally through the axis of rotation of the circular ring. As already explained above, this embodiment of a blade element 5 forms a truncated cone as an imaginary blade element cavity 15.

In this embodiment, the blade connecting device 8 can be designed as a form-fitting and/or force-fitting connection, preferably as a press connection, and can be connected or connected to the material feed unit 2.

FIG. 19 shows a perspective view from above of a round blade element 5 with a round cutting edge 11. The round blade element 5 is designed here in the form of a sleeve and is shown as a sectional view. The section runs centrally through the axis of rotation of the sleeve.

In this embodiment, the blade connecting device 8 can be designed as a form-fitting and/or force-fitting connection, preferably as a press connection, and can be connected to or connected with the material feed unit 2.

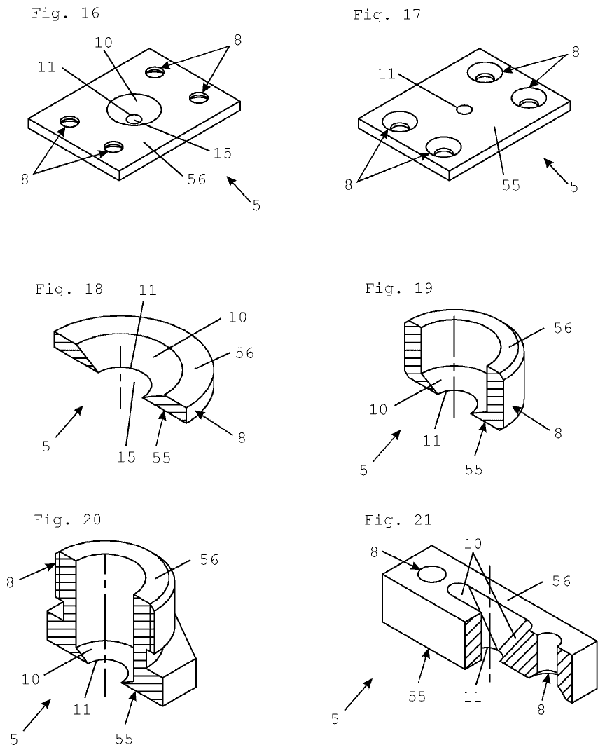

FIG. 20 shows a perspective view from above of a round blade element 5 with a round cutting edge 11. The round blade element 5 is designed here in the form of a sleeve and is shown as a sectional view. The section runs centrally through the axis of rotation of the sleeve.

In the embodiment shown in FIG. 20, the sleeve-shaped blade element 5 has part of a blade connecting device 8, wherein the part of the blade connecting device 8 is designed as an external thread.

FIG. 21 shows a perspective view from above of a block-shaped blade element 5.

The block-like blade element 5 has a round, for example elliptical, cutting edge 11, the hole formed thereby representing the tapered end of a wedge-shaped through-opening through the blade element 5. On the blade upper side 56, the upper end of the wedge-shaped through-opening corresponds to a long hole. Next to the elongated hole, there are further through openings on both sides, which have countersunk holes on the blade underside 55 in order to be able to receive countersunk screws, as shown in FIG. 13, and thus connect the blade element 5 to the material feed unit 2.

In a preferred embodiment, shown in FIGS. 12 to 21, the underside of the cutting surface 9 can be essentially congruent with the underside of the blade element 55.

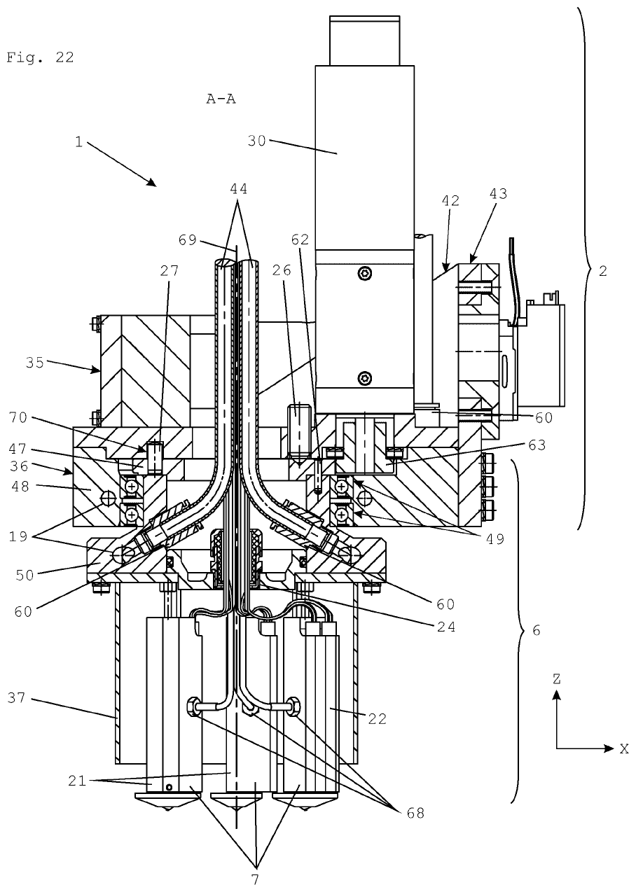

FIG. 22 shows a side view of the extrusion head 1 from FIG. 1 with a first variant of a cooling device 19, shown as a sectional view based on section A-A.

The sectional view A-A in FIG. 22 shows the extrusion head 1 with a sectional plane lying in the XZ plane and passing through the axis of rotation 69 from FIG. 4. In other words, the sectional plane runs along the XZ plane and centrally through the extrusion head 1; exactly between the two material receiving nozzles 33 and 34 from FIG. 4.

As already described in FIG. 4, the sectional view in FIG. 22 shows the extrusion head 1 with its individual parts, whereby the following parts can be seen in the material feed unit 2: the extrusion block 35, the displacement unit receiving block 36, which in turn comprises the heat sink 48 and the cooling device 19, the displacement actuator 30, one of the visible beveled side walls 42, the rear wall 43 with a recess for the tilting shaft 38 and the coolant interfaces 60. In addition, in contrast to FIG. 4, this view shows that at least one locking means 26 and one transmission wheel 63 are also provided in the material feed unit 2.

Drives for moving components of the excursion head 1 can be chain drives, belt drives, swivel mechanisms consisting of cylinders with racks and pinions, or other drives known from the prior art.

The locking means 26 releasably locks the displacement unit 6, which is movable relative to the material feed unit 2. For this purpose, the at least one locking means 26 can determine positions of the displacement unit 6, whereby an exact position of the liquefying assemblies 7 can be achieved. In other words, the at least one locking means 26 can be used to determine intermediate positions or end positions of the displacement unit 6.

This has the advantage that additional braking devices in or on the drive, in particular in or on the displacement actuator 30, can be dispensed with.

In a preferred embodiment, the at least one locking means 26 can be operated mechanically and/or electromechanically and/or pneumatically and/or hydraulically and/or electromagnetically.

In a preferred embodiment, as shown in FIG. 22, the at least one locking means 26 can be a spring-loaded pressure piece, preferably a spring-loaded ball pressure piece.

The transmission wheel 63 transmits movement from the displacement actuator 30 to the drive wheel 47 of the displacement unit 6. This means that the displacement unit 6 can be driven by the force transmission of the displacement actuator 30 via the transmission wheel 63.

It should be noted that the displacement unit 6 can also be driven by alternative force transmission means such as chain drives or belt drives or rope drives or coupling rods and/or alternative drive forms such as an electromechanical and/or pneumatic and/or hydraulic cylinder swivel mechanism.

The displacement unit 6 is connected to the material feed unit 2 via the bearings 49, which, as shown here but not necessarily, may be designed as roller bearings, and is thus rotatably mounted. The displacement unit 6 comprises several components, of which the following can already be seen in FIG. 4: the drive wheel 47, the cooling block 50 including the cooling device 19, the casing 37, and the liquefying assemblies 7. In contrast to FIG. 4, the following components are also visible here: at least one stop 27, at least one centering device 62, and two additional coolant interfaces 60.

The stop 27 can be a bolt-shaped stop, as shown here, wherein the stop is fastened in or on the drive wheel 47 and can be guided in a stop guide 70 in the material feed unit 2, which runs radially around the axis of rotation 69 of the displacement unit 6. The stop guide 70 can be designed so that the stop guide 70 does not form a closed guide but has a component that blocks the stop 27 or two blocking ends. In this way, it can be provided that the displacement unit 6 can only be moved to a certain extent relative to the material feed unit 2.

Specifically, it may be provided as an embodiment that the stop 27 can only be guided 120° within the stop guide 70 extending radially around the axis of rotation 69 before the stop 27 and thus the displacement unit 6 is blocked. This can be particularly advantageous if, as can be clearly seen in FIG. 2, six liquefying assemblies 7 are provided in the displacement unit. In this case, for example, three liquefying assemblies 7 arranged one after the other can form a first set 21 and the remaining three liquefying assemblies 7 arranged one after the other can form a second set 22. The first set of liquefying assemblies 7 can be provided for a first extrusion material, whereby each of the three liquefying assemblies 7 of the first set 21 is preferably equipped with a different nominal width of the nozzle for different pressure accuracies. The same applies to the second set 22 for a second extrusion material 3. In order to prevent contamination with different extrusion materials 3 within the individual liquefying assemblies 7, the stop 27 within the stop guide 70 can be used to ensure that a feed line 14 with a first extrusion material 3 feeds only the first set 21 and a second feed line 14 with a second extrusion material 3 feeds only the second set 22. Of course, embodiments are not limited to two extrusion materials 3 and/or two sets 21, 22 and/or six liquefying assemblies 7, but may also have more or fewer extrusion materials 3 and/or sets 21, 22 and/or liquefying assemblies 7.

In a preferred embodiment, the restriction of the angle of rotation of the displacement unit 6 relative to the material feed unit 2 by the stop 27 can also serve as a protective function, in that the stop 27 prevents the lines 44 from being torn off, for example by over-rotating the displacement unit 6 due to a possible electrical malfunction of the displacement actuator 30 or by the extrusion head 1 colliding with an object printed in the installation space or similar.

In a preferred embodiment, the stop 27 can be used to move the displacement unit 6 to the end positions in an incremental position measuring system for referencing the displacement unit 6.

In a preferred embodiment, the stop 27 can be used in conjunction with the locking means 26 as a precise and, above all, cost-effective positioning means, particularly in the end positions. After the stop 27 within the stop guide 70 comes into contact with the component or ends blocking the stop, the displacement unit 6 can be moved relative to the material feed unit 2 after the displacement actuator 30 is switched off by means of the locking means 26, preferably a spring-loaded ball pressure piece, in the provided locking recesses 54, preferably countersunk holes.

The centering means 62 serves to center the drive wheel 47 relative to the rest of the displacement unit 6. As shown here, the centering means 62 can be a key.

In addition to a coolant interface 60 in the material feed unit 2, two further coolant interfaces 60 are visible in FIG. 22 in the displacement unit 6. One of the two coolant interfaces 60 visible in the material feed unit 2 can serve as a supply line and/or return line for a coolant in order to cool the material feed unit 2 with the aid of the cooling device 19 in the material feed unit 2, specifically in the heat sink 48. The two coolant interfaces 60 in the displacement unit 6 can serve as an inlet point and/or outlet point for a coolant in order to cool the displacement unit 6 with the aid of the cooling device 19 in the displacement unit 6, specifically in the cooling block 50. The coolant interfaces 60 of the displacement unit 6 may preferably be designed as push-fit connections.

In a preferred embodiment, all or individual coolant interfaces 60 may be provided on one or more inner walls of the displacement unit 6, preferably in the inner cylindrical cavity of the cooling block 50.

As shown in FIG. 22, the lines 44 run from above through the extrusion block 35, the displacement unit receiving block 36 of the material feed unit 2 and further through the cooling block 50 of the displacement unit 6, where the lines 44 split.

In a preferred embodiment, the lines 44 can run essentially along the axis of rotation 69.

Some of the lines 44 are cooling lines which contain a coolant and can feed and/or discharge the coolant, preferably under pressure, to the coolant interfaces 60 of the displacement unit 6.

Some of the lines 44 are cables that run through the cooling block 50 of the displacement unit 6, passing through a cable feedthrough 24 and leading to the individual liquefying assemblies 7. The lines 44, which lead as cables to the liquefying assemblies 7, can fulfill several functions. For example, as shown in FIG. 22, each liquefying assembly can be supplied with energy, preferably electrical energy, in order to provide the heating power required for softening and/or melting the at least one extrusion material. On the other hand, at least one measuring device 68, preferably one measuring device 68 per liquefying assembly 7, can be wired to some of the lines 44 in order to transmit measurement signals via the wiring.

In a preferred embodiment, the at least one measuring device 68 can be a temperature sensor that measures the temperature, preferably inside, of one of the existing liquefying assemblies 7.

The number, position, and function of the measuring devices 68 can be freely selected. For example, a measured value can be measured at all points of the extrusion head 1 and/or several measuring devices 68 can be arranged on the same component, preferably on one of the existing liquefying assemblies 7. In addition to temperature sensors or instead thereof, other measuring devices 68 can be provided, such as pressure sensors or position sensors. The number, position, and function of the at least one measuring device are therefore not limited to the embodiments shown.

The coolant interfaces 60 in the material feed unit 2 and in the displacement unit 6 serve, as explained in more detail above, to supply the extrusion head 1 with a coolant. It may be provided that, as shown in FIG. 22, the cooling devices 19 in the material feed unit 2 and in the displacement unit 6 are arranged as bores within the extrusion head 1. The coolant can be passed through the extrusion head 1 through such bores and cool it.

In the case of the material feed unit 2, as shown here, a cooling device 19 may consist of several bores which are arranged at the level of the bearings 49 and thus cool both the material feed unit 2, in particular the heat sink 48 of the material feed unit 2, and the bearings 49. In this way, the at least one cooling device 19 in the material feed unit 2 can be used to cool the at least one displacement unit 6 and/or the at least one extrusion material 3 and/or the separating device 4 and/or the at least one blade element 5 and/or the at least one conveying device 16, 40 and/or the at least one extrusion actuator 31, 32 and/or the displacement actuator 30 and/or the bearings 49 and/or the seals and/or the convection shield 25.

In the case of the displacement unit 6, a cooling device 19 may be provided, as shown here, which consists of several bores and is arranged in the cooling block 50 of the displacement unit 6. In this way, the at least one cooling device 19 in the displacement unit 6 can serve to cool the bearings 49 and/or the at least one extrusion material 3 and/or indirectly via the drive wheel 47 to cool the separating device 4 and/or the at least one blade element 5.

As shown in FIG. 22, all cooling devices 19 can be arranged below the drive wheel. This arrangement offers the advantage that heating of the at least one extrusion material 3 and/or the separating device 4 and/or the blade element 5 and/or the at least one conveying device 16, 40 and/or the at least one extrusion actuator 31, 32 and/or the displacement actuator 30 and/or softening of the at least one extrusion material 3, for example due to the heat rising from the liquefying assemblies 7 or the rising heat of the heated installation space, can be prevented.

It may be preferred that the at least one cooling device 19 is arranged in the region after, preferably directly after, the severing point of the at least one extrusion material 3.

It is also conceivable that the at least one cooling device 19 can be arranged at all possible locations within and/or outside the extrusion head 1, as long as the at least one cooling device 19 is a component of the extrusion head 1 or is connected to the extrusion head 1. The embodiments shown are therefore not to be understood as limiting with regard to the number, position, and/or coolant used for the cooling devices 19 shown and described here.

In a preferred embodiment, it may be provided that either one type of coolant, such as water, or more than one type of coolant, such as water and a cooling emulsion, is used.

FIG. 23 shows a side view of the extrusion head 1 with a second variant of a cooling device 19, shown as a sectional view.

The extrusion head 1 in FIG. 23 is very similar to that in FIG. 22, whereby a second embodiment of a cooling device 19 is provided in the displacement unit 6. Unless otherwise stated in the following description of the figures and/or in FIG. 23, what has already been said about the extrusion head 1 in FIG. 22 also applies to the extrusion head 1 in FIG. 23.

In a preferred embodiment, as shown in FIG. 23, the coolant interfaces 60 can be arranged partially or completely on the upper side of the displacement unit receiving block 36. The cooling device 19 can have bores in the cooling block 50, radially circumferential grooves on the circumference of a distributor 65 and axial bores within the distributor 65, as well as preferably one or more push-fit connections for supplying or discharging the coolant. Bores within the distributor 65 can connect the coolant interfaces 60 of the distributor 65 to the radially circumferential grooves of the distributor 65. A fluid connection can also exist between the radially circumferential grooves and the bores in the cooling block 50.

The distributor 65 can preferably consist of and/or comprise a substantially cylindrical component, as shown in FIG. 23, wherein a collar may preferably be provided at the upper end in order to be inserted into the displacement unit receiving block 36 and held there. The distributor 65 can have a cable feedthrough 24 at the lower end, which cable feedthrough can preferably be designed as a slip ring with at least one seal. In this way, electrical lines can be looped through the distributor 65 to supply the liquefying assemblies 7 with power.

As is generally known, cooling bores, i.e., bores in the existing cooling devices 19, are closed off to the outside by sealing means 72. Such a sealing means 72 can be clearly seen in FIG. 23 and can be used for all embodiments mentioned here if necessary. The sealing means 72 may preferably be a sealing screw.

In order to seal the fluid connections between the radial grooves of the distributor 65 and the holes in the cooling block 50, the fluid connections can be arranged by means of seals above, below and/or between the fluid connections.

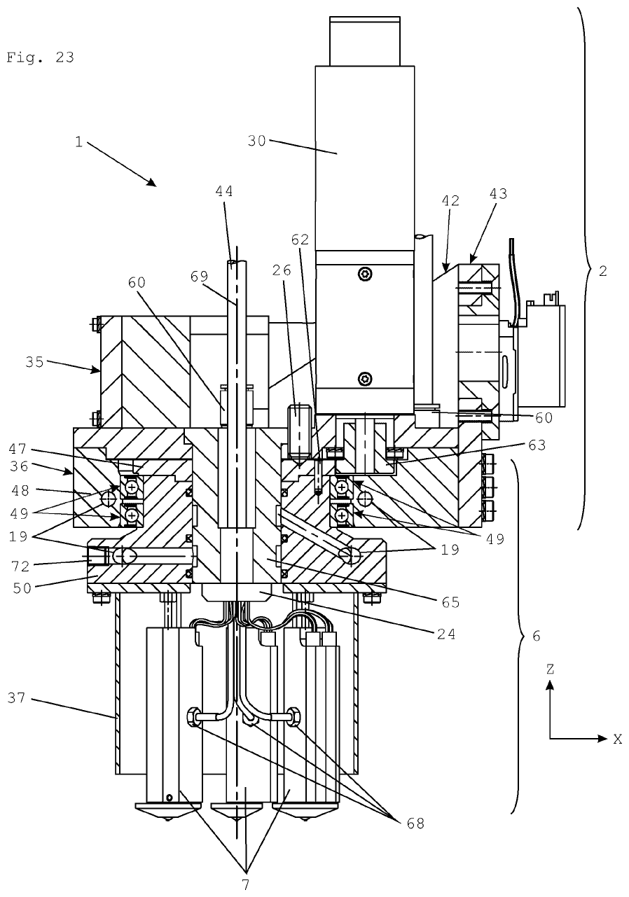

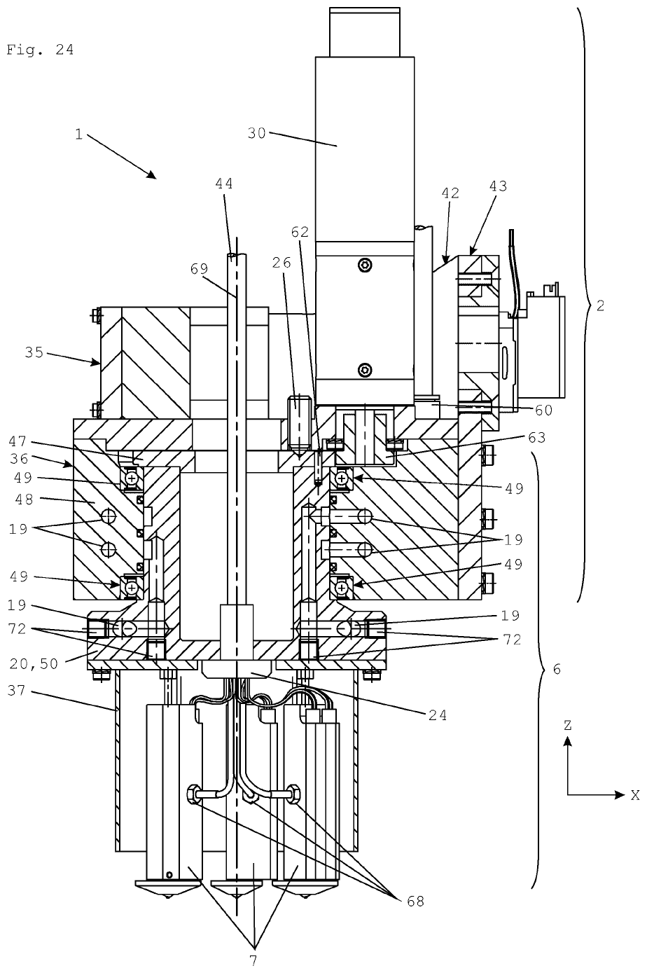

FIG. 24 shows a side view of the extrusion head 1 with a third variant of a cooling device 19, shown as a sectional view.

The extrusion head 1 in FIG. 24 is very similar to that in FIG. 23, whereby a third embodiment of a cooling device 19 is provided in the displacement unit 6. Unless otherwise stated in the following description of the figures and/or in FIG. 24, the above statements regarding the extrusion head 1 in FIG. 23 also apply to the extrusion head 1 in FIG. 24.

In a preferred embodiment, as shown in FIG. 24, two coolant interfaces 60 may be provided, wherein the coolant interfaces 60 may be arranged on the upper side of the displacement unit receiving block 36, wherein in FIG. 24 only one of the two coolant interfaces 60, which are preferably arranged symmetrically about the plane XZ of the extrusion head 1, is visible. These coolant interfaces 60 can supply the cooling device 19 in the displacement unit receiving block 36 with coolant, wherein the cooling circuit can run both through the displacement unit receiving block 36 of the material feed unit 2 and through the cooling block 50 of the displacement unit 6. In order to achieve a closed cooling circuit incorporating the material feed unit 2 and the displacement unit 6, bores may be provided in the displacement unit mounting block 36, bores in the cooling block 50 and radially circumferential grooves in the cooling block 50. The coolant flows from the first of the two coolant interfaces 60 through the holes in the displacement unit receiving block 36 until the coolant is then fed through corresponding holes into a radially circumferential groove in the body 50 of the displacement unit 6. The cooling circuit can continue through holes within the cooling block 50 and be fed back into the displacement unit mounting block 36 via a second radially circumferential groove of the cooling block 50, ending in the second of the two coolant interfaces 60. In such a preferred embodiment, it may be provided that the two bearings 49 are arranged at a distance from each other and that the cooling device 19 is arranged at least partially between these two bearings 49.

Preferred embodiments of the extrusion head 1, as shown in FIG. 23 and/or FIG. 24, advantageously enable, in particular through the use of a cable feedthrough 24 designed as a slip ring and/or a distributor 65 and/or a cooling block 50 designed as a cooling rotary feedthrough 20, to cause endless rotation of the displacement unit 6 without failure of the lines 44, for example by tearing off the lines 44.

FIG. 25 shows a perspective view of the displacement unit 6 from FIG. 1 without liquefying assemblies 7.

As is known from the previous FIGS. 4 and 22 to 24, the displacement unit 6 can comprise the drive wheel 47, the cooling block 50, the casing 37, a stop 27 and the six liquefying assemblies 7, wherein in FIG. 25 the liquefying assemblies 7 have been omitted for reasons of clarity.

In this view, one of the sealing means 72 for closing the bores of the cooling device 19 in the displacement unit 6 is clearly visible. Due to the hexagonal shape of the cooling block 50, viewed from top to bottom, the cooling device 19 has six holes, preferably six blind holes, with at least six sealing means 72. One of the two coolant interfaces 60 through which the coolant can be fed or discharged is also clearly visible.

On the upper side of the drive wheel 47 there are several recesses, including a stop recess 51 with a stop 27 located therein and two of four recesses provided for a detachable connection, preferably a screw connection, between the drive wheel 47 and the cooling block 50.

The stop recess 51 can perform a protective function in conjunction with the stop 27. In the case of at least two extrusion materials 3, for example a building material and a support material, at least two guide paths, as described in FIG. 4, and several, for example six, liquefying assemblies 7, wherein a first set 21 of the liquefying assemblies 7 contains an extrusion material 3 for forming a product, specifically the building material, and a second set 22 of the liquefying assemblies 7 contains a different extrusion material 3 for forming a support structure for the product, specifically the support material, it may be useful to provide a stop 27. This stop 27 can be inserted into the stop recess 51 and, in combination with the stop guide 70, see FIG. 22, prevents the displacement unit 6 from being turned too far. In this way, it can be ensured that the first set 21 of liquefying assemblies 7 can be supplied exclusively with the extrusion material 3 for constructing a product, specifically the building material, and the second set 22 of liquefying assemblies 7 can be supplied exclusively with the extrusion material 3 for constructing a support structure for the product, specifically the support material. Since the one stop 27 can be inserted into the stop recess 51 and the stop guide 70 preferably has two end positions, the circular offset movement of the displacement unit 6 can be limited both during clockwise rotation and during counterclockwise rotation and thus prevented from over-rotating.

FIG. 26 shows a perspective view of the displacement unit 6 from FIG. 1 with liquefying assemblies 7.

In FIG. 26, the opposite half of the displacement unit 6 of the section shown in FIG. 25 is visible. The liquefying assemblies 7 are also shown, whereby the liquefying assemblies 7 are fastened to the casing 37 by fastening means. Washer plates 53 made of materials with low heat transfer coefficients, preferably stainless steel or ceramic, in particular zirconium oxide ceramic, may be provided between the liquefying assemblies 7 and the casing 37 at the fastening means. The comments made in relation to FIG. 25 apply mutatis mutandis to FIG. 26.

FIG. 26 shows the locking recesses 54 located on the upper side of the drive wheel 47 of the displacement unit 6 and the at least one centering means 62. The locking recesses 54 can serve to lock the locking means 26 of the material feed unit 2 into one of the locking recesses 54, thereby locking the position of one of the existing liquefying assemblies 7 and its line, in particular its receiving device 18 and/or transfer line 17, can be precisely locked by the displacement unit 6 in relation to the material feed unit 2. The locking recesses 54 can, for example, be designed as countersunk holes.

The number, shapes, and positions of the stop recesses 52, the stop 27, the stop guide 70, and/or the locking recesses 54, as well as the locking means 26, are not limited to the embodiments shown.

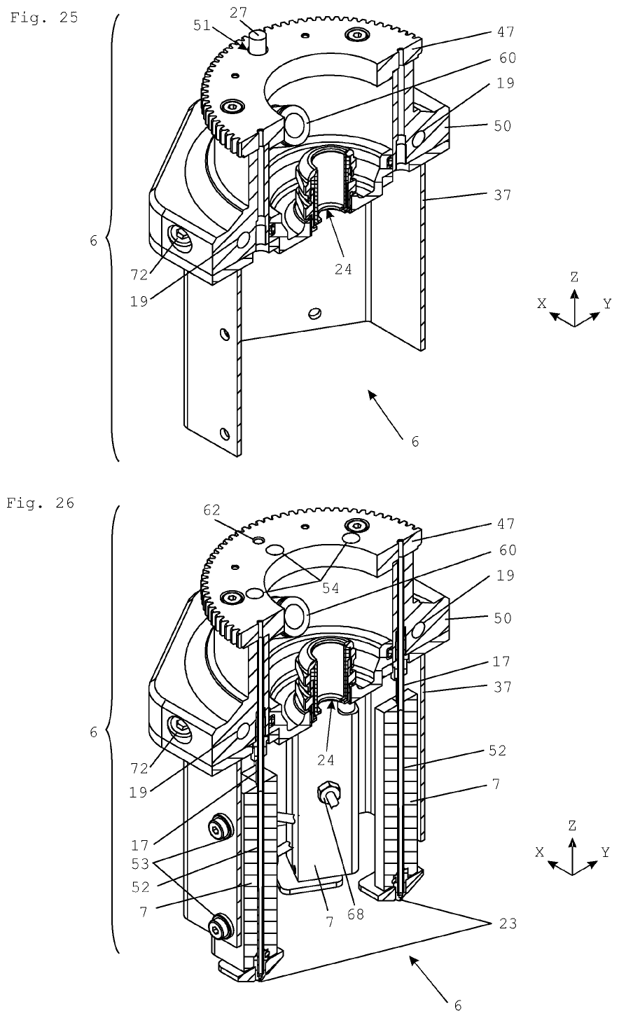

FIG. 27 shows a detailed view of a nozzle of a liquefying assembly of an extrusion head based on detail II from FIG. 4.

In a preferred embodiment, as shown in FIG. 27, the nozzles 77 arranged in and/or on the liquefying assemblies 7 may have a nozzle tip 78, the lower end of which comprises a nozzle channel 23, wherein the nozzle tip 78 is surrounded by a nozzle tip shield 59. The nozzle tip shield 59 can serve to mechanically protect the liquefying assemblies 7 and/or to contain the heat radiation emanating from the liquefying assemblies 7 toward the printed object. Furthermore, the nozzle 77 may have a nozzle tube 52, wherein the nozzle tube 52 contains the extrusion material 3, which it receives from the transfer line 17 and discharges through the nozzle channel 23. A heating block 61, preferably a two-part heating block 61, is provided around the nozzle tube 52 to heat the extrusion material 3 in the nozzle tube 52. Between the nozzle tip 78 and the heating block 61, a receiving element 64, preferably a dowel pin or a fitting screw, may be provided on or in the heating block 61. Furthermore, the nozzle tip 78 may have a radially offset groove 79, which is preferably formed perpendicular to the axis of rotation of the nozzle tube 52 and tangential to the circumference of the nozzle tip. By means of the receiving element 64 and a nozzle groove 79 formed in the nozzle tip 78, the nozzle 77 can preferably be releasably connected or connectable in a form-fitting manner in and/or on the heating block 61 of one of the liquefying assemblies 7.

In a preferred embodiment, it may be provided that the nozzle tube 52 and/or the nozzle tip 78 are connected to the heating block 61 in a ma\hat{ }1w2terial-locking, form-fitting and/or force-fitting, in particular friction-fitting, with the heating block 61, preferably by means of a detachable clamping connection of the split halves of the heating blocks 61 by means of a screw connection.

In a preferred embodiment, a combination of a previously mentioned connection by means of a receiving element 64 with a nozzle groove 79 formed in a nozzle tip 78 and a force-fitting, in particular friction-locking, connection between the nozzle tube 52 and/or nozzle tip 78 and the heating block 61 may be provided.

The embodiments of the attachment of the nozzles 77 in and/or on the liquefying assemblies 7 are not limited to the embodiments shown in FIG. 27 and described above.

In a preferred embodiment, the nozzle channel 23 may be tilted relative to a longitudinal extension direction 67. This may have the advantage that, when the displacement unit 6 and/or the extrusion head 1 is tilted, preferably relative to the axis of rotation 69 of the extrusion head 1, contact-free printing of the at least one extrusion material 3 can be ensured, whereby during the traversing movement of the extrusion head 1, the remaining liquefying assemblies 7 do not run the risk of coming into contact with the already printed product and/or the layer printed previously due to the tilt of the displacement unit 6 and/or the extrusion head 1. Preferably, the nozzle channel 23 can be tilted relative to a longitudinal extension direction 67 such that, after tilting the displacement unit 6 and/or the extrusion head 1, the nozzle channel 23 of the liquefying assemblies 7 in use for extruding an extrusion material 3 is aligned perpendicular to the platform 86 in order to be able to deposit further tracks without restriction from the previously produced tracks of a layer in the same printing layer.

In another preferred embodiment, it may be provided that the existing liquefying assemblies 7 can be inclined relative to each other with respect to the longitudinal extension direction 67. In addition, the imaginary axes of rotation of the nozzle tubes 52 may preferably intersect at a common point on the axis of rotation 69 of the displacement unit 6, preferably above the outlet of the nozzle channel 23, in particular at the level of the imaginary axis of rotation of the tilting shaft 38.

FIG. 28 shows a front view of the extrusion head 1 from FIG. 1, installed in a mounting structure 66, shown with a partially cut front panel 75 of the mounting structure.

This illustration shows that the extrusion head 1 is surrounded by a mounting structure 66. The support bracket 28 of the extrusion head 1 supports the mounting structure 66, whereby the extrusion head 1 and the mounting structure 66 are movable via the support bracket 28 in at least one direction, preferably in several directions, preferably in two, and particularly preferably in three directions.

In a further preferred embodiment, it may be provided that the mounting structure 66 supports the support bracket 28 of the extrusion head 1, whereby the extrusion head 1 is movable via the mounting structure 66 in at least one direction, preferably in several directions, preferably in two, and particularly preferably in three directions.

The mounting structure 66 in FIG. 28 has a rear panel 73, two side panels 74, and a front panel 75. The mounting structure 66 can be fastened to the support bracket 28 via the rear panel 73. In this installed state, the extrusion head 1 is surrounded by the rear panel 73, the two side panels 74, and the front panel 75.

In the lower right-hand area of the illustration in FIG. 28, the front panel 75 is shown cut off on the right-hand side. This allows the cooling block 50 of the displacement unit 6 behind it to be clearly seen. The displacement unit receiving block 36 is arranged above the cooling block 50 of the displacement unit 6.

A convection shield 25 is visible between the extrusion head 1, specifically the material feed unit 2, or more specifically the displacement unit receiving block 36, and the mounting structure 66, specifically one of the two side panels 74. The convection shield 25 is attached to the extrusion head 1 and the mounting structure 66 by means of a convection shield connection device 39.

The convection shield divides the space inside and/or outside the mounting structure 66 or, in relation to the extrusion head 1, into an installation space and a drive space. The installation space is the space in which the extrusion material 3 leaves the extrusion head through the nozzles 77 of the liquefying assemblies 7. The drive chamber is the space that is separated from the pressure chamber by the convection shield.

As indicated in FIG. 28, the convection shield 25 can connect the rear panel 73, the two side panels 74, and the front panel 75 of the mounting structure 66 to the extrusion head 1, wherein the convection shield may be arranged such that, within the mounting structure 66, there may be a space below the convection shield 25 in which the displacement unit 6 may be arranged, and another space above the convection shield 25 in which the material feed unit 2 may be arranged. The separation of the space below the convection shield 25, in particular the installation space, and the other space above the convection shield 25, in particular the drive space, can serve to prevent the ambient air heated in the space below the convection shield 25 by a heater, preferably by fan heaters, from flowing upward within the mounting structure 66 and thus cooling the extrusion material 3 and/or the material feed unit 2, in particular the separating device 4 and/or the at least one blade element 5 and/or the at least one conveying device 16, 40 and/or the at least one extrusion actuator 31, 32 and/or the displacement actuator 30.

The convection shield 25 can be flexibly deformable due to its shape and/or the material of which the convection shield 25 is at least partially made. In this way, it is possible to compensate for relative movements between the extrusion head 1 and the mounting structure 66 and, at the same time, to prevent the ambient air above and below the convection shield 25 from being exchanged and, furthermore, to ensure, for example, the homogeneity of the heated air in the installation space. This compensation of relative movements is particularly preferred when the extrusion head 1 is designed to be tiltable.

The convection shield 25 can be designed as a bellows, as shown in FIG. 28.

The convection shield 25 can be made of any material, preferably at least partially of silicate fabric and/or at least partially of aramid fabric, preferably of aluminized preox-para-aramid fabric, and/or at least partially of rubber, preferably of fluorinated rubber (FKM) or silicone rubber (HTV), and/or coated with any material, preferably partially with silicone and/or polytetrafluoroethylene.

The extrusion head 1 shown in FIG. 28, installed in the mounting structure 66, together with the convection shield 25, forms an arrangement. In this embodiment, this arrangement consists of the following components: the extrusion head 1, the convection shield 25, and the mounting structure 66, wherein a shield, in particular a dense and thermal shield, can be provided by the interconnected components as shown in FIG. 28.

In a preferred embodiment, as shown, it may be provided that the shielding is formed by the mounting structure 66, the material feed unit 2, the displacement unit 6, and the convection shield 25 between the mounting structure 66 and the extrusion head 1, in particular the material feed unit 2.

In a particularly preferred embodiment, it may be provided that the shielding is at least partially formed by the displacement unit receiving block 36 of the material feed unit 2 and by bearings 49 between the material feed unit 2 and the displacement unit 6, in particular roller bearings and/or plain bearings with or without their own seals, such as radial shaft seals, axial shaft seals, slide ring seals, groove rings, O-rings or bearing foils, as well as by the cooling block 50 and/or by the casing 37 and/or by a part of the existing seals, in particular O-rings, and/or cable feedthrough 24, preferably cable glands and/or electrical rotary feedthroughs designed as slip rings, which is mounted on the displacement unit 6.

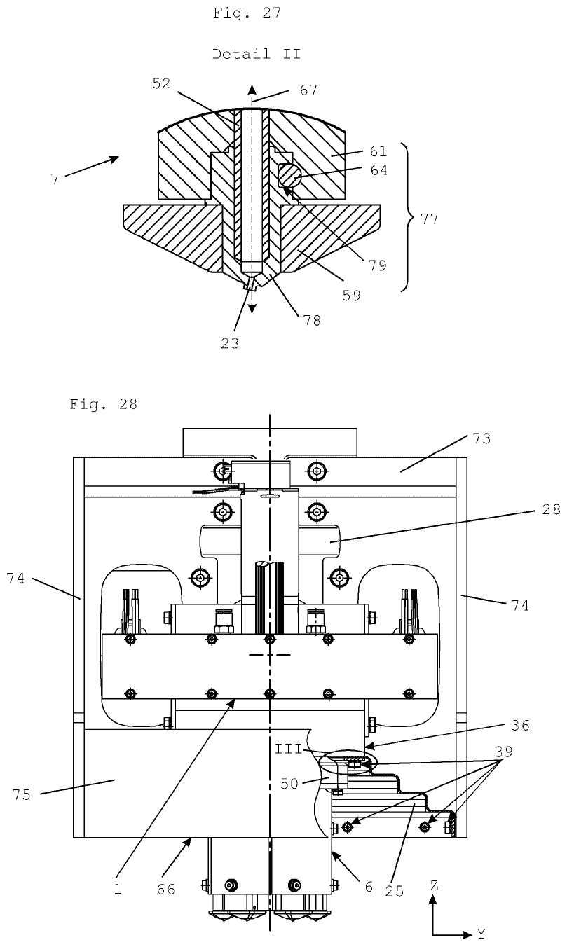

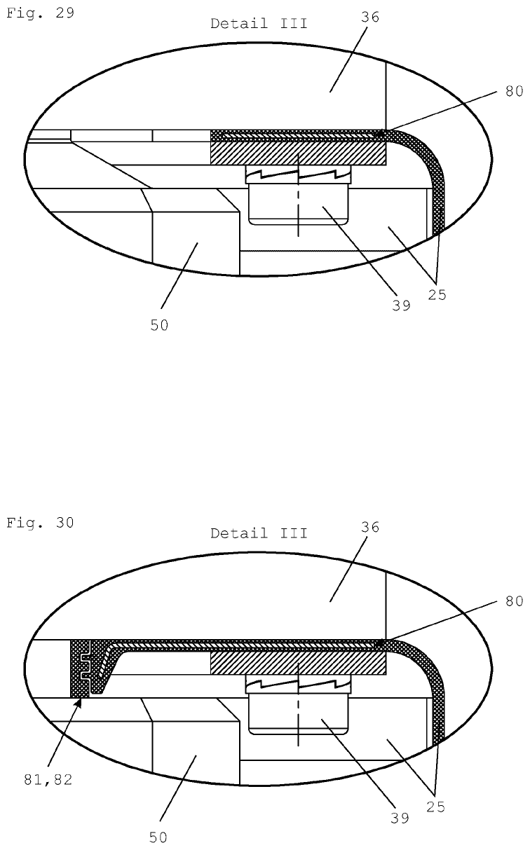

If the convection shield has a shaft seal 81, as shown in FIGS. 29 to 32, one or more seals in the form of separate components can thus be replaced and/or the need for high-temperature-resistant components above the shield can be avoided.

By shielding the arrangement, the operating space in which the arrangement is located and is used to manufacture a product can be divided into two areas, whereby, as shown here, the operating space is separated into an upper drive space and a lower installation space. An elevated temperature may prevail in the lower installation space as a result of the processing temperature of the extrusion material 3. The shielding prevents and/or reduces heat exchange, in particular by convection of the ambient air, from the lower installation space to the upper drive space. In this way, the arrangement can shield the separating device 4 from the area below the shielding, i.e., the installation space.

As shown in FIGS. 4, 22 to 24, the displacement unit 6 is arranged within the displacement unit receiving block 36, wherein the drive wheel 47 is provided in a recess, hereinafter referred to as the separating chamber, of the displacement unit receiving block 36. This separating chamber of the displacement unit receiving block 36 can be at least partially open at the top or closed or encapsulated with the exception of the feed line 14. The severing point of the extrusion material 3 can be designed as part of the separating chamber or as an additional separating chamber, whereby the area above the severing point can be separated so that convection of the waste heat from the drives can be prevented and/or reduced from above.

FIGS. 29 to 32 show different design variants of ends of a convection shield 25 based on detail III from FIG. 28.

FIG. 29 shows detail view III from FIG. 28. It can be seen that the convection shield 25 is connected to the displacement unit receiving block 36 by means of a convection shield connection device 39, shown here as a screw connection. The upper end of the cooling block 50 of the displacement unit 6 can be seen below the end of the convection shield 25 attached to the displacement unit receiving block 36. In addition, the area of the convection shield 25 that is connected to the displacement unit receiving block 36 via the convection shield connection device 39 is reinforced by a stiffener 80, in particular a stiffening ring.

FIG. 30 shows another embodiment of the convection shield 25 from the detailed view III in FIG. 28. In addition to what has already been said about FIG. 29, the convection shield 25 has an extended end. This extended end includes, on the one hand, a stiffener 80 that is extended and bent relative to FIG. 29 and, on the other hand, a shaft seal 81, shown here in the form of a labyrinth seal 82. The labyrinth seal 82 comprises two parts with corresponding contours, one part of the labyrinth seal 82 being in contact with the cooling block 50 and the other part of the labyrinth seal 82 being part of the base body of the convection shield 25.

FIG. 31 shows another embodiment of the convection shield 25 from the detailed view III of FIG. 28. In addition to what has already been said about FIG. 29, the convection shield 25 has an extended end. This extended end includes, on the one hand, a stiffener 80 that is longer than in FIG. 29 and, on the other hand, a shaft seal 81, shown here in the form of a radial sealing lip 83. The radial sealing lip 83 is in contact with the cooling block 50 and is tensioned by a tension spring 85, in particular by a self-contained ring spring, which generates a radial tensile force.

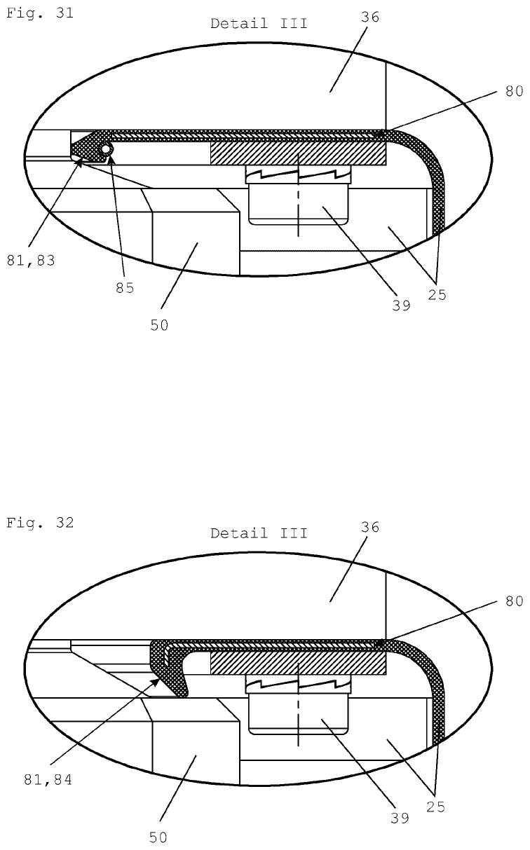

FIG. 32 shows another embodiment of the convection shield 25 from the detailed view III in FIG. 28. In addition to what has already been said about FIG. 29, the convection shield 25 has an extended end. This extended end comprises, on the one hand, a stiffener 80 which is extended and bent relative to FIG. 29 and, on the other hand, a shaft seal 81, shown here in the form of an axial sealing lip 84. The axial sealing lip 84 is in contact with the heat sink 50.

FIGS. 33 to 35 show different positions of the tiltable extrusion head 1 from FIG. 1.

In a preferred embodiment, as shown in FIGS. 33 to 35, the extrusion head 1 can be fastened to the support bracket 28 by means of the tilting shaft 38 in front of the return panel 73, in other words within the mounting structure 66, as already described above. The extrusion head 1 can then be tilted by means of the tilting actuator 29 via the tilting shaft 38 running through the support bracket 28, which can preferably serve as a force transmission device. The plane in which the extrusion head 1 can be tilted can be the YZ plane, as shown in FIGS. 33 to 35. The tilting shaft 38 thus represents, in other words, a swivel shaft and/or a transmission shaft.

The tiltable extrusion head 1 allows the displacement unit 6 with the liquefying assemblies 7 to be arranged so that only one nozzle 77 of a liquefying assembly 7 can be used for contact-free printing of the at least one extrusion material 3. Since the nozzle in use is arranged furthest down in the Z direction, there is no risk of the other nozzles of the liquefying assemblies 7 coming into contact with the product and/or the last layer printed when the extrusion head 1 located in the mounting structure 66 is moved. This applies in particular assuming that, during contact-free printing, a product is built up layer by layer in the Z direction and the extrusion head 1 located in the mounting structure 66 is moved in the XY plane to build up each individual layer.

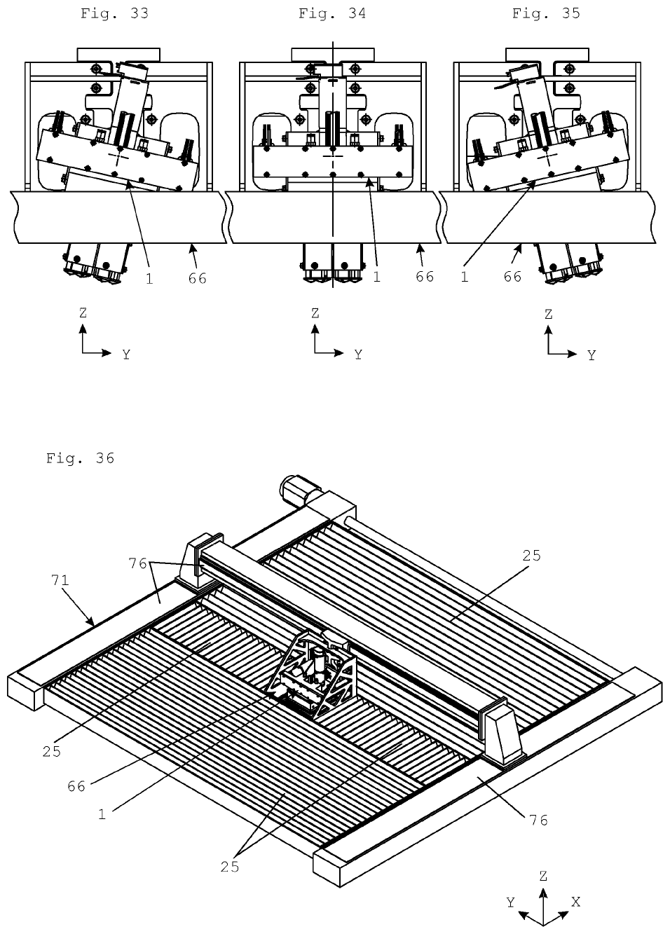

In the vertical starting position, in which the extrusion head 1 with all its liquefying assemblies 7 is aligned along the Z direction, as shown in FIG. 34, the extrusion head 1 can be tilted in two directions. The extrusion head 1, which can be tilted in two directions, makes it possible to move the extrusion head 1 into two tilt positions. This can be particularly advantageous when several liquefying assemblies 7 are used, whereby some of the existing liquefying assemblies 7 form a first set 21 and the remaining liquefying assemblies 7 form a second set 22. The first set 21 of the liquefying assemblies 7 can print a first extrusion material 3 with different accuracy due to liquefying assemblies 7 of the first set 21 with different nominal widths of the nozzle channels 23. In contrast, the second set 22 of liquefying assemblies 7 can print a second extrusion material 3 with different accuracy due to liquefying assemblies 7 of the second set 22 with different nominal widths of the nozzle channels 23. It is therefore possible, in a first tilted position of the extrusion head 1, shown in FIG. 35, to use the first set 21 for the structural construction of a product and, in this first tilted position, to switch between different liquefying assemblies 7 of the first set 21 with different nozzle nominal widths. When changing materials, the extrusion head can be moved from the first tilted position to the second tilted position, shown in FIG. 33, so that the second set 22 can be used for the structural construction of a support structure, whereby in this second tilted position it is possible to switch between different liquefying assemblies 7 of the second set 22 with different nominal widths of the nozzle.

To prevent an unwanted liquefying assembly 7 from being used in one of the possible tilted positions of the extrusion head 1, an over-rotation of the displacement unit 6 can be prevented by a stop 27 and/or a loosening can be prevented by a locking means 26, whereby only a specific liquefying assembly 7 and/or a specific number of liquefying assemblies 7 and/or a specific set of the liquefying assemblies 7 can be used.

FIG. 36 shows a perspective view of the extrusion head 1 with the mounting structure 66 from FIG. 35, implemented in a moving system 71.

When the mounting structure 66 is connected to the extrusion head 1, the mounting structure 66 together with the extrusion head 1 can be arranged within a moving system 71. With the aid of moving devices 76 of the moving system 71, the mounting structure 66 together with the extrusion head 1 can be moved, whereby it is preferably provided that the mounting structure 66 together with the extrusion head 1 can be moved in two, particularly preferably three directions.

In a preferred embodiment, as shown in FIG. 36, a convection shield 25 may be provided between the mounting structure 66 and at least one moving device 76 of the moving system 71. The convection shield between the mounting structure 66 and at least one moving device 76 of the moving system 71 can consist of one or more parts, in particular one or more folding roof covers.

The above statements regarding the convection shield 25 in FIG. 28 also apply mutatis mutandis to the convection shield 25 in FIG. 36.

In FIG. 36, in addition to the convection shield described in FIG. 28, a further convection shield is provided, which is arranged between the moving system 71 and the mounting structure 66. Analogous to the shielding in FIG. 28, shielding is provided in the embodiment of FIG. 36 by this extended arrangement. The shielding, which is thus also extended, separates the operating space into a drive space above the shielding and an installation space below the shielding over the entire span of the travel system in the XY plane, as explained above with reference to FIG. 28. In this way, thermal shielding of the installation space from the drive space can be achieved.

FIG. 37 shows an arrangement of the extrusion head 1 within the mounting structure 66 and a first platform 86.

In this illustration, the extrusion head 1 is in a tilted position within the mounting structure 66 and is arranged so that one of the nozzles 77 or one of the liquefying assemblies 7 can be pressed onto the platform 86.

In a preferred embodiment, the extrusion head 1 together with the mounting structure 66 and/or the platform 86 may be height-adjustable or height-controllable.

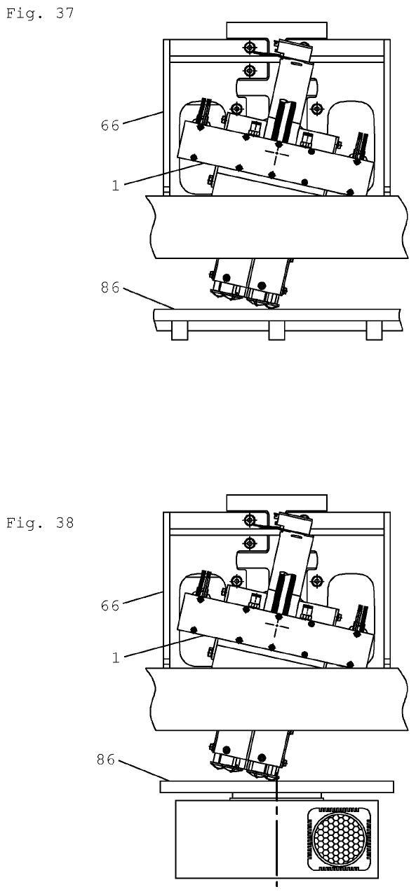

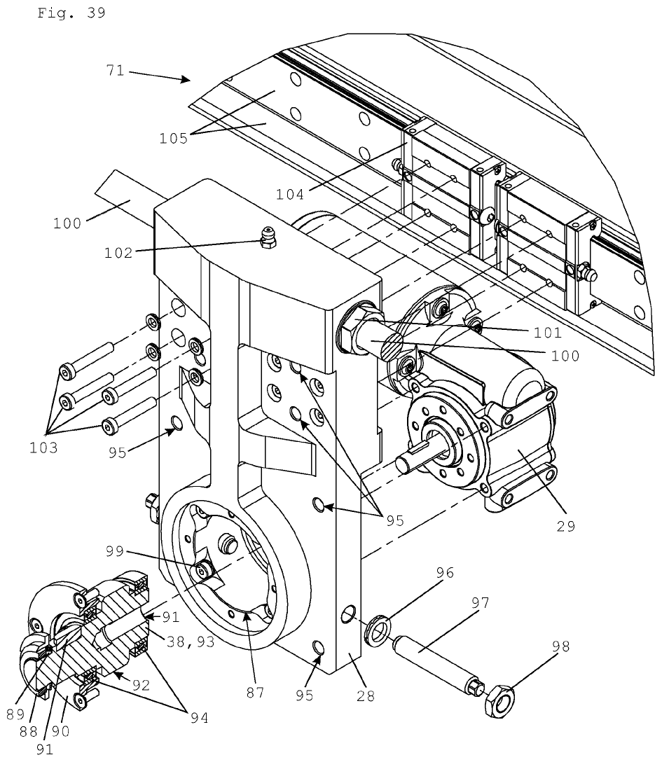

FIG. 38 shows an arrangement of the extrusion head 1 within the mounting structure 66 and a second platform 86.

This embodiment differs from the embodiment shown in FIG. 37 in that the platform 86 is designed as a rotary table.

In a preferred embodiment, the platform 86 can be designed as a rotary table whose axis of rotation is preferably aligned in the Z direction in order to provide an additional, for example fifth, axis for 5-axis additive manufacturing, preferably in order to produce complex geometries with undercuts layer by layer without the use of support structures, wherein the fourth axis can be realized by the tiltable extrusion head 1, more specifically by the tilting actuator 29. This can have the advantage that, by eliminating support structures, a different material with, for example, different material properties such as color and so on can be used. This results in time and cost savings. If the extruder is the fourth axis of the five-axis system, this can lead to lower energy consumption.

FIG. 39 shows an exploded view of the support bracket 28, the tilting actuator 29, the tilting shaft 38 or swivel shaft 93, and the moving system 71.

In this illustration in FIG. 39, the tilting shaft 38 is a swivel shaft 93. When installed, the swivel shaft 93 is located in a swivel shaft bearing seat 87 of the support bracket 28. The swivel shaft 93 is in contact with the support bracket 28 via a swivel shaft bearing 94 next to the swivel shaft collar 92. At least one bearing cover 90 may be provided to secure the swivel shaft bearings 94.

The slotted nut 88 can serve to axially secure the material feed unit 2 to the swivel shaft 93. The grub screw 89 can serve as a screw lock for the slotted nut 88. The swivel shaft 93 can be connected via the key connections 91 on the one hand to the material feed unit 2 and on the other hand to the motor shaft of the tilting actuator 29.

The extrusion head 1 can be fastened axially as a complete unit, as shown in FIG. 3, by means of the swivel shaft 93, preferably designed with key connections 91 and a slotted nut 88. For maintenance and/or repair purposes, the extrusion head 1 can be removed from the support bracket 28, preferably from the swivel shaft 93, in a short time, with little effort and at low cost from the arrangement shown in FIGS. 33 to 36 by loosening the slotted nut 88. To completely remove the extrusion head 1 from the system, the convection shield 25 can be removed by loosening the convection shield connection device 39.

The support bracket 28 has the mounting structure connection devices 95 for connection to the mounting structure 66, the carriage connection devices 103 for connection to the carriage 104, and the tilting actuator connection devices 99 for connection to the tilting actuator 29.

In addition, the arrangement in FIG. 39 has the following components in and/or on the support bracket 28: a wedge lock washer 96, an adjusting screw 97, a lock nut 98, wherein the adjusting screw 97 can serve as an adjustable stop for the swivel shaft 93, in particular for the swivel shaft collar 92, a threaded spindle 100, a spindle nut 101, wherein the spindle nut 101 can be a component of the support bracket 28, and a lubrication point 102.

As already mentioned, the support bracket 28 can be connected to the carriage 104 via the carriage connection devices 103. The carriage 104 is part of the moving system 71, which additionally has the profile rail guide 105 on which the carriage 104 can move.

### LIST OF REFERENCE SYMBOLS

1 Extrusion head
2 Material feed unit
3 Extrusion material
4 Separating device
5 Blade element
6 Displacement unit
7 Liquefying assemblies
8 Blade connection device
9 Cutting surface underside
10 Cutting surface upper side
11 Cutting edge
12 First cutting surface section
13 Second cutting surface section
14 Feed line
15 Blade element cavity
16 First conveying device
17 Transfer line
18 Receiving device
19 Cooling device
20 Cooling rotary feedthrough
21 First set of liquefying assemblies
22 Second set of liquefying assemblies
23 Nozzle channels
24 Cable feedthrough
25 Convection shield
26 Locking means
27 Stop
28 Support bracket
29 Tilting actuator
30 Displacement actuator
31 First extrusion actuator
32 Second extrusion actuator
33 First material receiving nozzle
34 Second material receiving nozzle
35 Extrusion block
36 Displacement unit receiving block
37 Casing
38 Tilting shaft
39 Convection shield connecting device
40 Second conveying device
41 Feed wheel
42 Beveled side wall
43 Rear wall
44 Lines
45 First material feed hose
46 Second material feed hose
47 Drive wheel
48 Heat sink of the material feed unit
49 Bearing
50 Cooling block of the displacement unit
51 Stop recess
52 Nozzle tube
53 Washer
54 Locking recess
55 Blade element underside
56 Blade element upper side
57 Projection
58 Guide recess
59 Nozzle tip shield
60 Coolant interface
61 Heating block
62 Centering means
63 Transmission wheel
64 Mounting element
65 Distributor
66 Mounting structure
67 Longitudinal direction
68 Measuring device
69 Rotation axis
70 Stop guide
71 Moving system
72 Locking means
73 Rear panel
74 Side panel
75 Front panel
76 Moving device
77 Nozzle
78 Nozzle tip
79 Nozzle groove
80 Stiffener
81 Shaft seal
82 Labyrinth seal
83 Radial sealing lip
84 Axial sealing lip
85 Tension spring
86 Platform
87 Swivel shaft bearing seat
88 Slotted nut
89 Grub screw
90 Bearing cover
91 Key connection
92 Swivel shaft collar
93 Swivel shaft
94 Swivel shaft bearing
95 Mounting structure connection device
96 Wedge lock washer
97 Adjusting screw
98 Lock nut
99 Tilting actuator connection device
100 Threaded spindle
101 Spindle nut
102 Lubrication point
103 Carriage connection device
104 Carriage
105 Profile rail guide

1. An extrusion head for additive manufacturing, preferably based on the fused filament fabrication method, of a product comprising:
at least one material feed unit for feeding at least one extrusion material, preferably in filament form,
a separating device with at least one blade element,
at least one displacement unit with at least two liquefying assemblies, wherein the at least one extrusion material can be introduced into a first liquefying assembly and, by passing the at least one displacement unit approximately gap-free past the separating device,
wherein the extrusion material can be brought close to the at least one blade element and can be severed at a severing point, and
wherein the upper end of the extrusion material severed by the separating device can be introduced into a second liquefier assembly, and
wherein the at least one blade element can be fastened or is fastened to or in the at least one material feed unit or is a component of the material feed unit.

2. The extrusion head according to claim 1, wherein the at least one blade element is round and/or angular.

3. The extrusion head according to claim 1, wherein the at least one blade element is designed as a flat plate or as a block or as a flat ring or as a sleeve.

4. The extrusion head according to claim 1, wherein the at least one blade element is connected to the at least one material feed unit by a blade connecting device, preferably wherein the blade connecting device can be non-destructively detached.

5. The extrusion head according to claim 1, wherein the at least one blade element has at least one straight and/or curved cutting edge with a cutting surface underside and a cutting surface upper side, wherein, in the state of the at least one blade element fastened to or in the material feed unit, the underside of the at least one blade element and the cutting surface underside face the displacement unit and the upper side of the at least one blade element and the cutting surface upper side face away from the displacement unit.

6. The extrusion head according to claim 5, wherein the cutting surface underside and the cutting surface upper side are inclined relative to each other, preferably at an angle of up to 55°, in particular at a very acute angle of 20 to 30°.

7. The extrusion head according to claim 5, wherein the cutting surface underside and/or the cutting surface upper side has at least two cutting surface sections, wherein the first cutting surface section is adjacent to the cutting edge and the second cutting surface section is not adjacent to the cutting edge.

8. The extrusion head according to claim 1, wherein the material feed unit has at least one feed line for the at least one extrusion material, wherein, in the state of the at least one blade element fastened to or in the material feed unit, the at least one feed line extends within the material feed unit up to a region in front of, in particular up to, the at least one blade element.

9. The extrusion head according to claim 8, wherein, in the state of the at least one blade element fastened to or in the material feed unit, the feed line ends in a region between the blade element underside and the blade element upper side.

10. The extrusion head according to claim 8, wherein the feed line has at least one guide recess which extends up to the separating device and through which the extrusion material is at least partially exposed.

11. The extrusion head according to claim 8, wherein the feed line has at least one projection, wherein, in the state in which at least one blade element is fixed to or in the material feed unit, the at least one projection projects into a region between the blade element underside and the blade element upper side, preferably wherein two projections are provided and, in the state of the at least one blade element fastened to or in the material feed unit, the two projections form a guide recess, in particular a groove, preferably a transverse groove, in a region between the blade element underside and the blade element upper side.

12. The extrusion head according to claim 8, wherein the feed line is provided as a separate component within the material feed unit or is an integral part of the material feed unit.

13. The extrusion head according to claim 1, wherein at least one conveying device of the material feed unit is provided for feeding the at least one extrusion material, wherein the at least one conveying device is designed to additionally return the, preferably severed, at least one extrusion material at least partially within the material feed unit.

14. The extrusion head according to claim 1, wherein the at least one displacement unit has at least one receiving device, preferably at least two receiving devices, particularly preferably one receiving device for each liquefier assembly.

15. A method and/or use for manufacturing a product with the extrusion head according to claim 1.
